(19) United States
(12) Patent Application Publication
(10) Pub. No.: US 2019/0068486 A1
(43) Pub. Date: Feb. 28, 2019

(54) TRANSMITTING APPARATUS, METHOD AND NON-TRANSITORY COMPUTER-READABLE STORAGE MEDIUM

(71) Applicant: FUJITSU LIMITED, Kawasaki-shi (JP)

(72) Inventor: AKIKAZU MAEHARA, Kasuga (JP)

(73) Assignee: FUJITSU LIMITED, Kawasaki-shi (JP)

(21) Appl. No.: 16/113,083

(22) Filed: Aug. 27, 2018

(30) Foreign Application Priority Data
Aug. 31, 2017 (JP) 2017-166453

(51) Int. Cl. H04L 12/703; H04L 12/24; H04L 12/707; H04L 12/26

(52) U.S. Cl. CPC H04L 45/28; H04L 41/0668; H04L 41/0677; H04L 43/16; H04L 45/24; H04L 43/0852; H04L 45/22

(57) ABSTRACT

A transmitting apparatus includes a memory, and a processor coupled to the memory and configured to receive a first packet including first data transmitted from a transmitting node via a first route; receive a second packet including the first data transmitted from the transmitting node via a second route different from the first route, identify, based on first time information regarding the first packet, a first state of the first route, and identify, based on second time information regarding the second packet, a second state of the second route, respectively, and when the first state is not in a first state range, execute a first failure monitoring process on the first route, and when the second state is not in a second state range, execute a second failure monitoring process on the second route, respectively.

### CROSS-REFERENCE TO RELATED APPLICATION

This application is based upon and claims the benefit of priority of the prior Japanese Patent Application No. 2017-166453, filed on Aug. 31, 2017, the entire contents of which are incorporated herein by reference.

### FIELD

The embodiment discussed herein is related to a transmitting apparatus, a method and a non-transitory computer-readable storage medium.

### BACKGROUND

As one of techniques for achieving high-quality data transmission, a redundant packet transmission system has been put to practical use. In the redundant packet transmission system, a packet transmitting apparatus transmits packets to a packet receiving apparatus via two physically different routes. The packets have added thereto the same sequence number and the same identifier. The packet receiving apparatus uses the sequence number and the identifier to identify the received packets. The packet receiving apparatus selects one of the same packets received via the two routes and transfers the selected packet to a client.

In addition, in order to achieve high reliability, uninterruptible switching has been put to practical use for the aforementioned redundant transmission system. The uninterruptible switching may enable packets to be continuously transferred without stopping a data stream even if a packet loss occurs in either one of the redundant routes or if a large delay occurs.

An uninterruptible packet transmitting apparatus has been proposed, which may restore an STM signal from a packet signal without instantaneous interruption even if a failure of a transmission path within a packet network, a packet loss in a transmission path, or a variation in a delay occurs. A method for referencing timestamp information and identifying and maintaining an interval between a received frame and a preceding frame has been proposed.

For a transmission system in which paths for a main signal are made redundant between multiple redundant systems, a device that monitors whether or not the paths for the main signal are normal is known. For a communication device having duplicate communication lines, an uninterruptible switching method for executing a normal switching operation even upon the occurrence of an abnormality that causes a 0 system and a 1 system to cancel alarms is known. As related-art documents, there are Japanese Laid-open Patent Publication No. 2012-178665, Japanese Laid-open Patent Publication No. 2013-012827, Japanese Laid-open Patent Publication No. 5-292113, and Japanese Laid-open Patent Publication No. 6-164559.

### SUMMARY

According to an aspect of the invention, a transmitting apparatus includes a memory, and a processor coupled to the memory and configured to receive a first packet including first data transmitted from a transmitting node via a first route, receive a second packet including the first data transmitted from the transmitting node via a second route different from the first route, identify, based on first time information regarding the first packet, a first state of the first route, and identify, based on second time information regarding the second packet, a second state of the second route, respectively, and when the first state is not in a first state range, execute a first failure monitoring process on the first route, and when the second state is not in a second state range, execute a second failure monitoring process on the second route, respectively.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a network used by packet transmitting apparatuses.

FIG. 2 is a diagram illustrating an example of hardware configurations of the packet transmitting apparatuses.

FIG. 3 is a diagram illustrating an example of each of packet transceivers.

FIG. 4 is a diagram illustrating an example of uninterruptible switching.

FIG. 5 is a diagram illustrating an overview of phase control.

FIG. 6 is a diagram illustrating an example of the calculation of clock time differences and corrected time.

FIG. 7 is a flowchart illustrating an example of a phase control process.

FIG. 8 is a flowchart illustrating an example of preprocessing for phase control.

FIGS. 9A and 9B are diagrams illustrating examples of an operation of a DEQ determiner.

FIG. 10 is a flowchart illustrating an example of failure monitoring.

FIG. 11 is a diagram illustrating a first example of the phase control and the failure monitoring.

FIG. 12 is a diagram illustrating a second example of the phase control and the failure monitoring.

FIG. 13 is a diagram illustrating a third example of the phase control and the failure monitoring.

FIGS. 14A and 14B are diagrams describing timestamps.

FIG. 15 is a diagram illustrating an example of a phase controller included in each of the packet transmitting apparatuses according to an embodiment.

FIG. 16 is a flowchart illustrating an example of a process to be executed by the phase controller.

FIG. 17 is a flowchart illustrating another example of the process to be executed by the phase controller.

FIG. 18 is a flowchart illustrating still another example of a process to be executed by the phase controller.

### DESCRIPTION OF EMBODIMENT

In conventional interruptible switching, a packet receiving apparatus determines whether or not a transmission system is normal based on the difference between transmission delays in two routes. If a failure is detected, the packet receiving apparatus autonomously executes a failure restoration process.

However, in the method for determining whether or not the transmission system is normal based on the difference between the transmission delays in the two routes, it may be determined that failures have occurred in both of the routes regardless of the fact that one of the routes is normal. In other words, erroneous detection may be executed. If such erroneous detection is executed, the transmission system may temporarily stop communication without providing interruptible switching regardless of the fact that one of the two routes is normal.

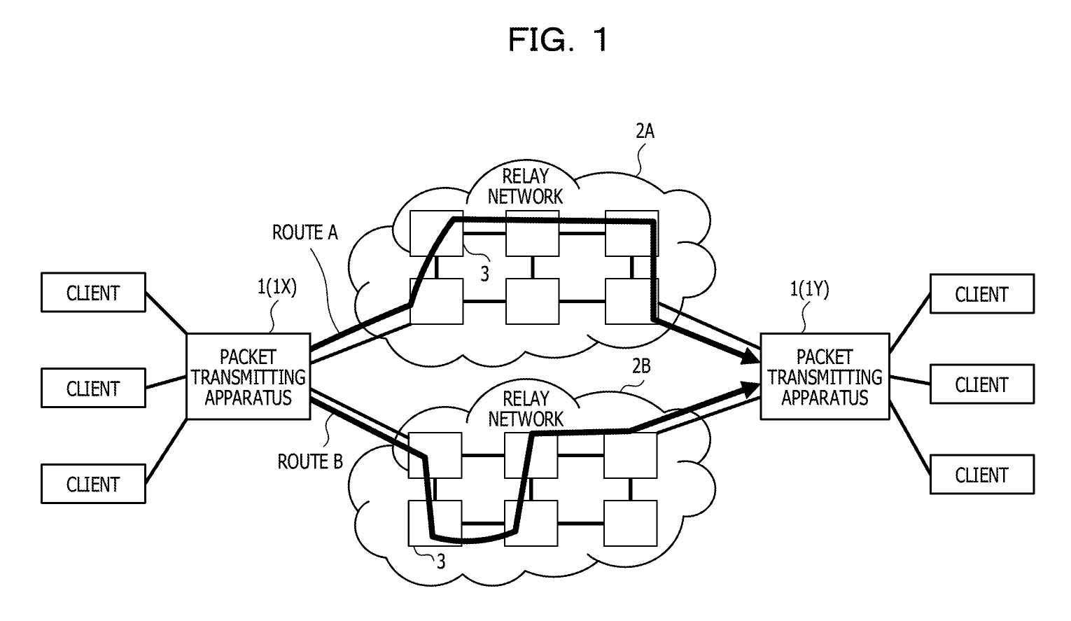

FIG. 1 illustrates an example of a network used by packet transmitting apparatuses according to an embodiment. Each of the packet transmitting apparatuses 1 (1X and 1Y) may host one or multiple clients. In addition, each of the packet transmitting apparatuses 1 is coupled to multiple relay networks. In the example illustrated in FIG. 1, the packet transmitting apparatuses 1 are coupled to a relay network 2A and a relay network 2B. A router 3 is included in each of nodes of the relay networks 2A and 2B. Each of the routers 3 is an example of a relay device and transfers a received packet toward a destination based on a header of the received packet.

Multiple paths are set between the packet transmitting apparatuses 1X and 1Y. In the example illustrated in FIG. 1, two paths are set so that the same packet is transmitted from the packet transmitting apparatus 1X to the packet transmitting apparatus 1Y via the relay network 2A and the relay network 2B. In other words, the same packet is redundantly transmitted from the packet transmitting apparatus 1X to the packet transmitting apparatus 1Y via the two physically different paths. In this example, Real-time Transport Protocol (RTP) packets are transmitted from the packet transmitting apparatus 1X to the packet transmitting apparatus 1Y, for example. FIG. 1 illustrates the relay networks 2A and 2B separated from each other. The relay networks 2A and 2B may not be physically separated from each other.

In the following description, routes of the two paths set via the relay networks 2A and 2B are referred to as “route A” and “route B” in some cases. The packet transmitting apparatus 1X that redundantly transmits a packet via the route A and the route B is referred to as “transmitting node”.

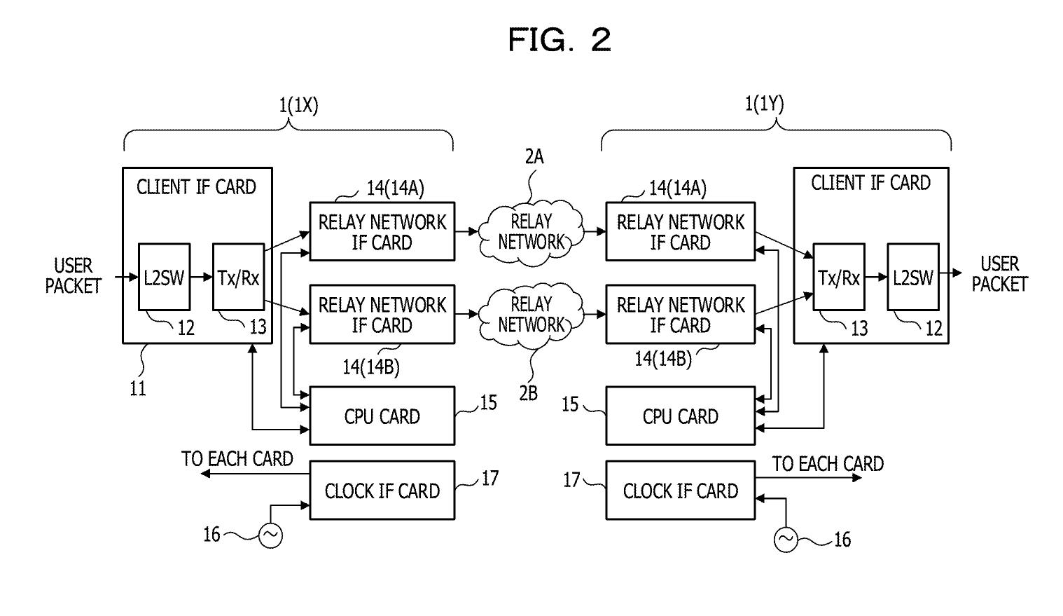

FIG. 2 illustrates an example of hardware configurations of the packet transmitting apparatuses. Each of the packet transmitting apparatuses 1 includes a client IF card 11, relay network IF cards 14 (14A and 14B), a CPU card 15, a clock generator 16, and a clock IF card 17. The packet transmitting apparatuses 1 may include another element or function that is not illustrated in FIG. 2.

The client IF card 11 may host a client. A client line is achieved by Ethernet (registered trademark), for example. In addition, the client IF card 11 includes an L2 switch 12 and a packet transceiver 13. The L2 switch 12 controls a band and packet processing in the layer 2. The packet transceiver 13 provides an uninterruptible switching function. The relay network IF cards 14 provide interfaces between the packet transmitting apparatus 1 and the relay networks 2A and 2B. Specifically, each of the relay network IF cards 14 exchanges a signal format between the packet transmitting apparatus 1 and the relay networks 2A and 2B. The CPU card 15 sets software in the packet transmitting apparatus 1, outputs an alarm, collects statistical information, and the like. The clock IF card 17 generates a clock signal for the inside of the packet transmitting apparatus 1 based on a clock signal output from the clock generator 16 and supplies the generated clock signal to each of the other cards.

In the case where data is transmitted from the packet transmitting apparatus 1X to the packet transmitting apparatus 1Y, the packet transmitting apparatus 1X redundantly outputs the same packets to the relay networks 2A and 2B. In this case, the packet transmitting apparatus 1Y receives the packets via the relay networks 2A and 2B. Then, the packet transmitting apparatus 1Y selects one of the two received packets and transfers the selected packet to a destination client. In this manner, the packet transmitting apparatuses 1X and 1Y provide redundant packet transmission.

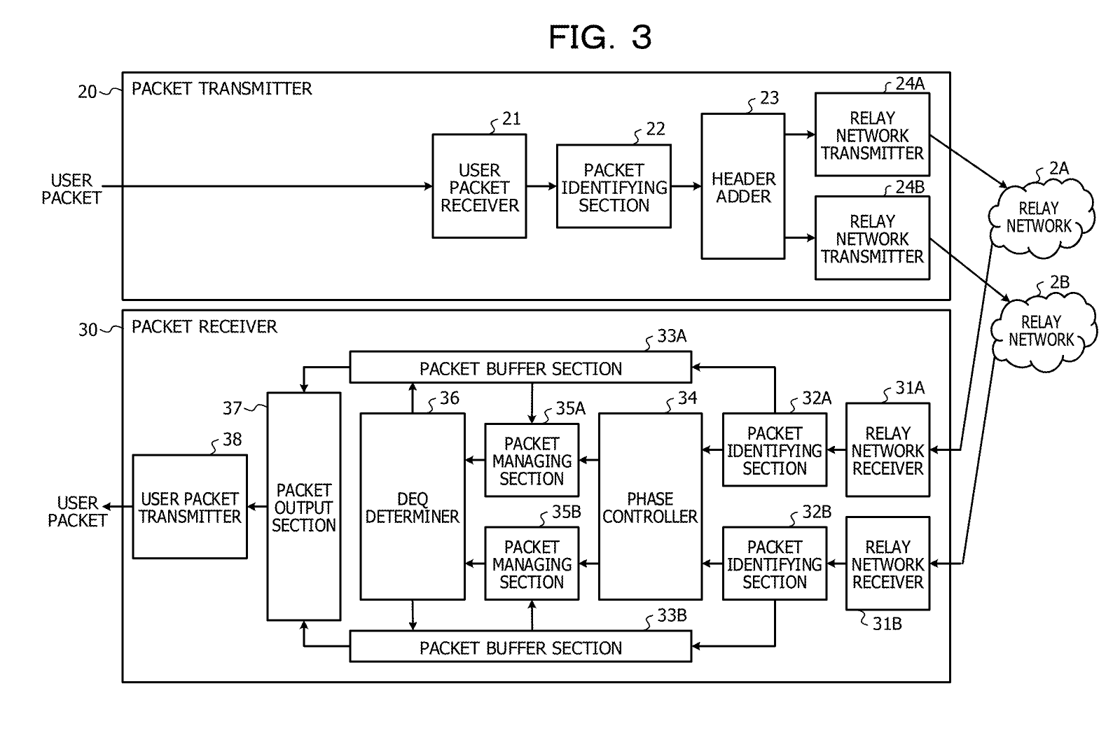

FIG. 3 illustrates an example of each of the packet transceivers 13. Each of the packet transceivers 13 includes a packet transmitter 20 and a packet receiver 30, as illustrated in FIG. 3.

The packet transmitter 20 includes a user packet receiver 21, a packet identifying section 22, a header adder 23, and relay network transmitters 24A and 24B. The packet transmitter 20 may include another element or function that is not illustrated in FIG. 3. In addition, the relay network transmitters 24A and 24B may be included in the relay network IF cards 14A and 14B illustrated in FIG. 2, respectively.

The user packet receiver 21 terminates a user packet output from a client terminal. In addition, the user packet receiver 21 uses forward error correction (FEC) to check the normality of the user packet. In this case, an abnormal packet is discarded.

The packet identifying section 22 identifies a flow based on a header (or a VLAN tag) of the user packet and determines whether or not an uninterruptible switching process is to be executed on the user packet. Whether or not the uninterruptible switching process is to be executed is determined for each flow in advance, for example. In the following description, a packet to which the uninterruptible switching process is applied is referred to as “uninterruptible packet” in some cases. In addition, a packet to which the uninterruptible switching process is not applied is referred to as “normal packet” in some cases.

The header adder 23 adds an intra-apparatus header to the user packet. The intra-apparatus header includes control information to be used by the packet transmitting apparatus 1. Specifically, the intra-apparatus header includes an uninterruptible flag indicating whether or not the uninterruptible switching is to be executed, and a flow number identifying the flow. In addition, the header adder 23 adds an uninterruptible header to an uninterruptible packet. The uninterruptible header includes a sequence number (SN) and a timestamp (TS). For each flow, a sequence number is generated. The timestamp indicates the time when the packet transmitter 20 receives the user packet from the client terminal. The timestamp is an example of time information.

In the case where the packet transmitter 20 transmits a normal packet, the header adder 23 transfers the normal packet to either one of the relay network transmitters 24A and 24B. On the other hand, in the case where the packet transmitter 20 transmits an uninterruptible packet, the header adder 23 transfers the uninterruptible packet to both of the relay network transmitters 24A and 24B.

The relay network transmitters 24A and 24B convert a signal format between the packet transmitting packet 1 and the relay networks 2A and 2B. A packet output from the relay network transmitter 24A is transmitted via the relay network 2A. A packet output from the relay network transmitter 24B is transmitted via the relay network 2B.

As illustrated in FIG. 3, the packet receiver 30 includes relay network receivers 31A and 31B, packet identifying sections 32A and 32B, packet buffer sections 33A and 33B, a phase controller 34, packet managing sections 35A and 35B, a DEQ determiner 36, a packet output section 37, and a user packet transmitter 38. The packet receiver 30 may include another element or function that is not illustrated in FIG. 3. In addition, the relay network receivers 31A and 31B may be included in the relay network IF cards 14A and 14B illustrated in FIG. 2, respectively.

The relay network receivers 31A and 31B terminate packets received from the relay networks 2A and 2B, respectively. In addition, the relay network receivers 31A and 31B use FEC to check the normality of user packets. In this case, an abnormal packet is discarded.

Each of the packet identifying sections 32A and 32B determines whether a received packet is an interruptible packet or a normal packet based on an intra-apparatus header added to the received packet. In addition, the packet identifying sections 32A and 32B transmit data (hereinafter referred to as packet data) stored in the received packets to the packet buffer sections 33A and 33B. Furthermore, the packet identifying sections 32A and 32B transmit information (hereinafter referred to as packet information) stored in each of headers of the received packets to the phase controller 34. The packet information includes a flow number, uninterruptible flag, a sequence number, and a timestamp.

The packet buffer sections 33A and 33B write the packet data received from the packet identifying sections 32A and 32B to buffer memories. In this case, the packet buffer sections 33A and 33B notify write pointers and length information indicating lengths of the packet data to the packet managing sections 35A and 35B. In addition, based on a DEQ instruction from the DEQ determiner 36, the packet buffer sections 33A and 33B read corresponding packet data from the buffer memories and transmit the packet data to the packet output section 37.

The phase controller 34 generates packet control information for each received packet and gives the packet control information to the packet managing sections 35A and 35B. The packet control information includes a flow number, an uninterruptible flag, a sequence number, and scheduled output time information. Scheduled output time is calculated as follows.

If the packet receiver 30 receives an uninterruptible packet, the phase controller 34 uses a timestamp of the received packet to calculate a clock time difference. The clock time difference is the difference between time indicated by a clock of the transmitting node and time indicated by a clock of the receiving node (or target node). Specifically, the clock time difference indicates a transmission delay between the transmitting node and the receiving node. A clock time difference is calculated for each of the routes A and B. In addition, the phase controller 34 calculates a delay difference between the routes A and B based on the clock time difference calculated for the route A and the clock time difference calculated for the route B. The delay difference corresponds to the difference between the clock time difference calculated for the route A and the clock time difference calculated for the route B. Specifically, the delay difference corresponds to the difference between a transmission delay in the route A and a transmission delay in the route B. The phase controller 34 calculates scheduled output time of each packet based on the delay difference between the routes A and B and a predetermined fluctuation reduction time period. If the packet receiver 30 receives a normal packet, the “current time” is set as scheduled output time.

The packet managing sections 35A and 35B use FIFO memories to manage the packet control information received from the phase controller 34 and the write pointers and length information received from the packet buffer sections 33A and 33B. Then, the packet managing sections 35A and 35B notify packet control information stored in tops of the FIFO memories to the DEQ determiner 36.

When the current time reaches scheduled output time of a received packet, the DEQ determiner 36 gives a DEQ instruction to a packet buffer section 33A or 33B storing the packet. In this case, if the target of the DEQ instruction is an uninterruptible packet, the packet control information is referenced and uninterruptible switching control is executed to select one of the packet buffer sections 33A and 33B. The DEQ instruction includes a flow number, an uninterruptible flag, and a selection or non-selection identifier. The selection or non-selection identifier indicates the result of the selection by the uninterruptible switching control.

The packet output section 37 introduces the packet output from the packet buffer section 33A or 33B to the user packet transmitter 38. In this case, the packet output section 37 processes an uninterruptible packet based on a selection or non-selection identifier. Specifically, the packet read from the selected packet buffer section 33A or 33B is introduced to the user packet transmitter 38, and a packet read from the other packet buffer section 33A or 33B is discarded. In addition, the packet output section 37 executes output interruption monitoring on an uninterruptible flow and notifies the result of the output interruption monitoring to the phase controller 34. The output interruption monitoring is executed to monitor whether or not intervals at which packets are output are normal.

The user packet transmitter 38 outputs the packet received from the packet output section 37 to a user network. In this case, the user packet transmitter 38 converts a signal format between the packet transmitting apparatus 1 and the user network.

<Description of Uninterruptible Switching>

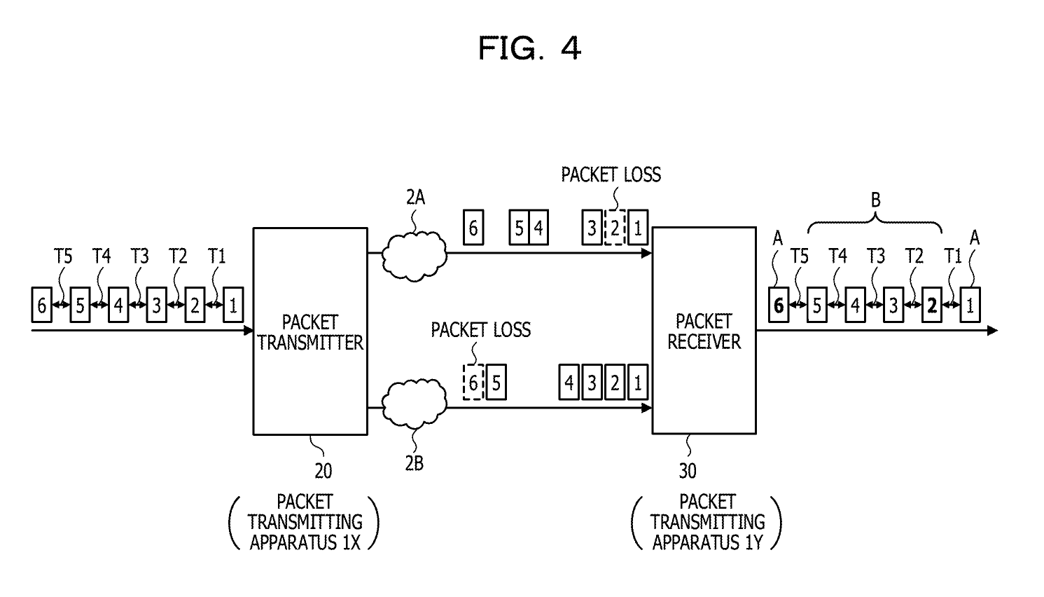

FIG. 4 illustrates an example of the uninterruptible switching. In this example, uninterruptible packets 1 to 6 are transmitted from the packet transmitter 20 of the packet transmitting apparatus 1X to the packet receiver 30 of the packet transmitting apparatus 1Y. The uninterruptible packets 1 to 6 are redundantly transmitted via the relay networks 2A and 2B. T1 to T5 indicate intervals between the packets.

The packet transmitter 20 adds a sequence number and a timestamp to each of the packets transmitted from a client and copies the packets after the addition of the sequence numbers and the timestamps. Then, the packet transmitter 20 outputs each of the packets to the relay networks 2A and 2B. Specifically, the same packet is redundantly transmitted via the routes A and B. In the example illustrated in FIG. 4, the packet 2 is lost in the relay network 2A, and the packet 6 is lost in the relay network 2B. In addition, as illustrated in FIG. 4, the intervals between the packets may fluctuate in the relay networks 2A and 2B.

The packet receiver 30 executes the uninterruptible switching on the packets received via the routes A and B. Specifically, upon receiving the packets 1 via the routes A and B, the packet receiver 30 selects either one of the received packets 1 and transfers the selected packet 1 to a destination client. In this example, the packet 1 received via the route A is transferred to the destination client. Next, the packet receiver 30 receives the packet 2 via only the route B. In this case, the packet receiver 30 transfers the packet 2 to the destination client. Subsequently, the packets 3 to 5 received via the route B are transferred to the destination client. After that, the packet receiver 30 receives the packet 6 via only the route A. In this case, the packet 30 transfers the packet 6 to the destination client.

In the aforementioned uninterruptible switching, the packet receiver 30 controls intervals at which the packets are output. Specifically, the timing of outputting the packets is adjusted so that the intervals at which the packets are output from the packet receiver 30 are equal to the intervals T1 to T5 at which the packets have been input to the packet transmitter 20 of the transmitting node. Thus, fluctuations in intervals between the packets in the relay networks 2A and 2B are reduced and the intervals at which the packets have been input to the packet transmitter 20 are achieved on the output side of the packet receiver 30 again.

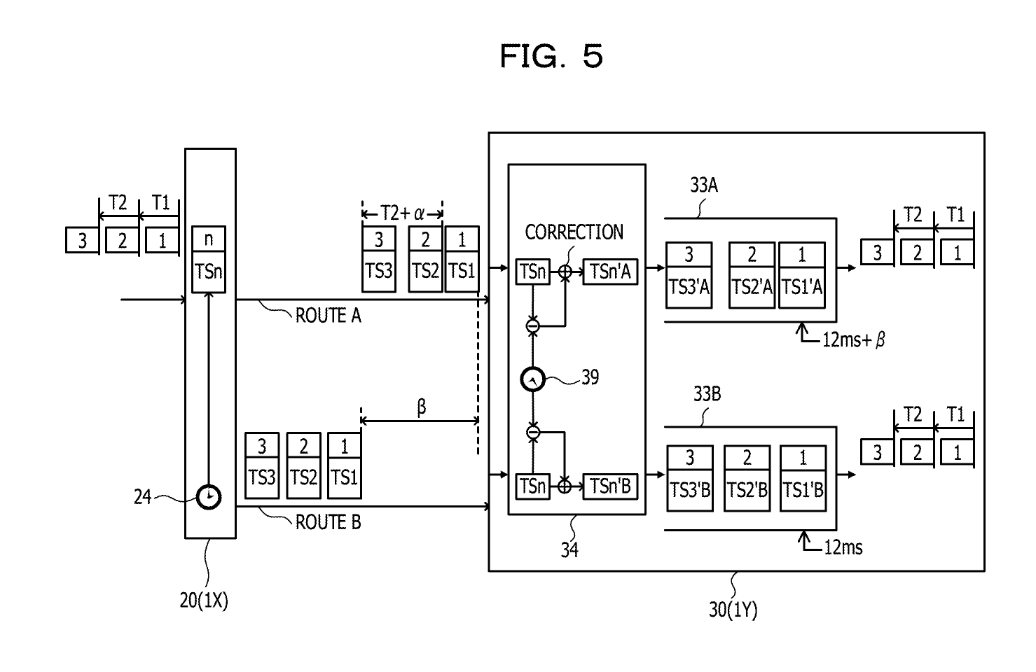

FIG. 5 illustrates an overview of phase control. In an example illustrated in FIG. 5, uninterruptible packets 1 to 3 are transmitted from the packet transmitter 20 of the packet transmitting apparatus 1X to the packet receiver 30 of the packet transmitting apparatus 1Y. T1 and T2 indicate intervals between the packets.

The packet transmitter 20 adds a sequence number and a timestamp to each of the packets, as described above. The sequence number is incremented one by one. The timestamp is generated based on a clock 24 included in the packet transmitter 20. The clock 24 is achieved by a real time clock (RTC), for example. In FIG. 5, a “sequence number (n)” and a “timestamp (TSn)” are indicated for each of the packets.

The packet transmitter 20 redundantly outputs the packets to the relay networks 2A and 2B. Specifically, the same packet is transmitted via the routes A and B. In the example illustrated in FIG. 5, an interval between the packet 2 and the packet 3 is increased by α in the route A. In addition, a transmission delay in the route B is longer by β than a transmission delay in the route A.

In the packet receiver 30, the phase controller 34 calculates scheduled output time of each of the packets for each of sides. Specifically, the phase controller 34 calculates scheduled output time of each of the packets for each of the sides A and B. The “sides” correspond to the routes between the packet transmitting apparatuses 1X and 1Y and include the paths on the routes and processing systems. Specifically, the side A includes the path on the route A and a circuit that processes a packet received via the route A. The side B includes the path on the route B and a circuit that processes a packet received via the route B.

The packet receiver 30 includes a clock 39. The clock 39 is achieved by an RTC, for example. A clock frequency of the clock 24 is equal to a clock frequency of the clock 39. The phase controller 34 calculates, for each of the sides A and B, the difference between a timestamp of a received packet and reception time indicated by the clock 39. Specifically, a clock time difference A indicating the difference between the clock 24 and the clock 39 for the side A and a clock time difference B indicating the difference between the clock 24 and the clock 39 for the side B are measured. In addition, the phase controller 34 generates, for the side A, a corrected timestamp TSn′A by correcting a timestamp of a received packet based on the clock time difference A. In addition, the phase controller 34 generates, for the side B, a corrected timestamp TSn′B by correcting a timestamp of a received packet based on the clock time difference B. Specifically, a timestamp based on the clock 24 is converted to a timestamp based on the clock 39 for each of the sides A and B. Thus, the corrected timestamps indicate time information based on the clock 39. In the following description, a corrected timestamp is referred to as “corrected time” in some cases.

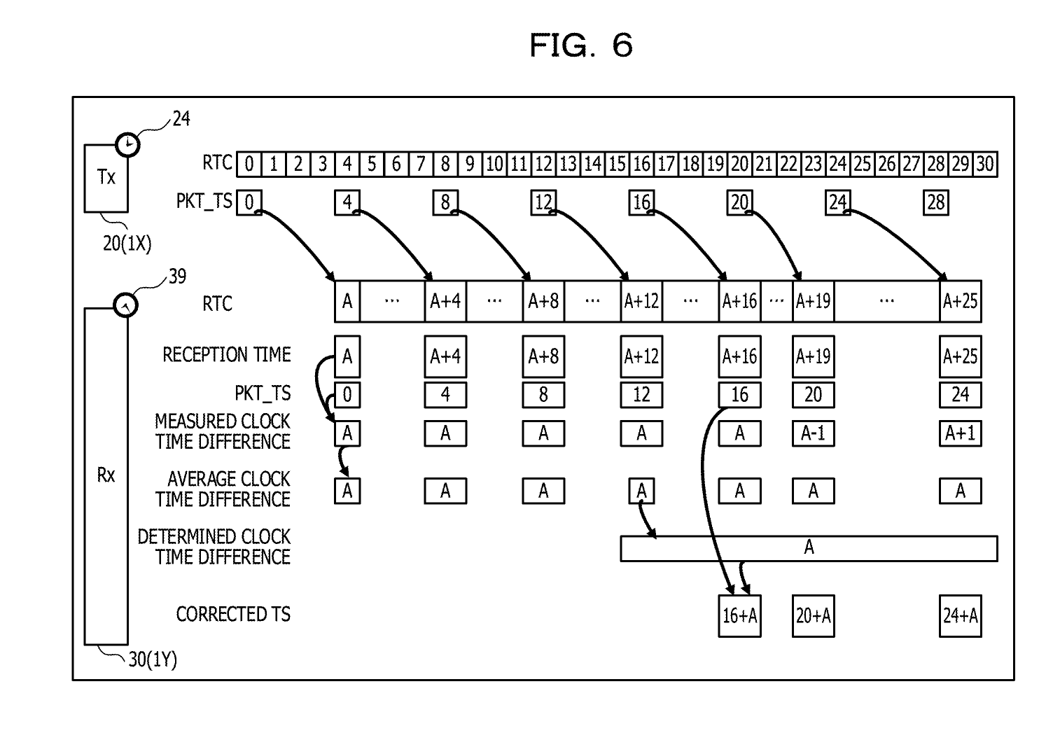

FIG. 6 illustrates an example of the calculation of the clock time differences and the corrected time. In the example illustrated in FIG. 6, the clock 24 and the clock 39 provide RTC, respectively. RTC indicates values of counters that operate based on predetermined clock frequencies. The clock frequencies of the clocks 24 and 39 are equal to each other. FIG. 6 illustrates an operation of any of the sides A and B.

In the packet transmitter 20 of the packet transmitting apparatus 1X, an RTC value output from the clock 24 is added as a timestamp to each of packets. Then, the packet transmitter 20 transmits the packets at predetermined time intervals. In this example, the packets are transmitted at time intervals of 4 counts.

In the packet receiver 30 of the packet transmitting apparatus 1Y, the phase controller 34 calculates corrected time (or a corrected timestamp) for each of the received packets. For example, a packet transmitted from the packet transmitter 20 at time 0 indicated by the clock 24 arrives at the packet receiver 30 at time A indicated by the clock 39. In this case, “0” is added as a timestamp to the packet. “PKT_TS” illustrated in FIG. 6 indicates timestamps added to the packets. The phase controller 34 calculates a clock time difference “A (=A−0)” indicating the difference between the timestamp added to the received packet and the reception time indicated by the clock 39. After that, the phase controller 34 calculates a clock time difference every time the packet receiver 30 receives a packet. In this case, the phase controller 34 calculates the average of clock time differences calculated for received packets. The average clock time difference is calculated according to the following equation, for example. An average clock time difference [i]=(1−α)×an average clock time difference [i−1]+α×a clock time difference [i], where i indicates the number of times that an averaging process is executed, and a indicates an averaging coefficient that is larger than 0 and smaller than 1. In the example illustrated in FIG. 6, the average clock time difference is “A”.

When a predetermined fluctuation reduction time period elapses after the packet receiver 30 receives an initial packet, the phase controller 34 outputs a determined clock time difference. The fluctuation reduction time period corresponds to the maximum fluctuation time period in which the maximum fluctuation may occur in a network. In addition, the determined clock time difference is an average clock time difference obtained when the fluctuation reduction time period elapses. In the example illustrated in FIG. 6, the determined clock time difference is “A”. The determined clock time difference is stored in a predetermined register.

In addition, the phase controller 34 calculates corrected time (or a corrected timestamp) by adding the determined clock time difference to a timestamp added to a received packet. For example, a packet transmitted from the packet transmitter 20 at time 16 indicated by the clock 24 arrives at the packet receiver 30 at time A+16 indicated by the clock 39. In this case, the determined clock time difference is “A”. Thus, a corrected timestamp “16+A” is obtained by adding the determined clock time difference “A” to a timestamp “16” of the received packet.

In the example illustrated in FIG. 6, intervals at which packets arrive at the packet receiver 30 are not fixed due to a fluctuation of the network. For example, three packets transmitted by the packet transmitter 20 at time “16”, “20”, and “24” arrive at the packet receiver 30 at time “A+16”, “A+19”, and “A+25”. Specifically, the second packet arrives “1” earlier and the third packet arrives “1” later. Corrected time obtained by the phase controller 34, however, is “16+A”, “20+A”, and “24+A”, and intervals between the packets are fixed. In this manner, the phase controller 34 may reduce fluctuations in intervals between packets in the network.

Return to the description of FIG. 5. The phase controller 34 calculates a delay difference between the side A and the side B. The delay difference indicates the difference between an average clock time difference of the side A and an average clock time difference of the side B. The average clock time difference of the side A corresponds to a transmission delay in the route A, while the average clock time difference of the side B corresponds to a transmission delay in the route B. Thus, the delay difference indicates the difference between the transmission delay in the route A and the transmission delay in the route B. In the example illustrated in FIG. 5, the delay difference corresponds to delay time 13. The delay difference has a sign. The sign indicates that a transmission delay in either one of the routes A and B is shorter than a transmission delay in the other one of the routes A and B. Thus, the sign of the delay difference indicates a side including a route via which a packet arrives earlier. In the example illustrated in FIG. 5, packets arrive via the side A (or the route A) earlier.

For example, if the average clock time difference of the side A is “70” and the average clock time difference of the side is “60”, the delay difference is calculated as follows. The delay difference=70−60=+10. In this case, the delay difference “+10” indicates that a packet transmitted via the route B arrives at the packet receiver 30 “10” earlier than a packet transmitted via the route A.

In addition, if the average clock time difference of the side A is “50” and the average clock time difference of the side is “60”, the delay difference is calculated as follows. The delay difference=50−60=−10. In this case, the delay difference “−10” indicates that a packet transmitted via the route A arrives at the packet receiver 30 “10” earlier than a packet transmitted via the route B.

In addition, the phase controller 34 calculates scheduled output time of each of packets for each of the sides A and B. Scheduled output time is calculated based on a corrected timestamp, the maximum fluctuation time period, and the delay difference. Specifically, scheduled output time T (earlier) of a received packet of an earlier arrival side and scheduled output time T (later) of a received packet of a later arrival side are calculated according to the following equations. T (earlier)=a corrected timestamp+the fluctuation reduction time period+the delay difference. T (later)=a corrected timestamp+the fluctuation reduction time period. A corrected timestamp is obtained by adding an average clock time difference or a determined clock time difference to a timestamp added to a received packet, as described above. The fluctuation reduction time period corresponds to the maximum fluctuation time period in which the maximum fluctuation may occur in the network. The fluctuation reduction time period is obtained in advance by simulation or measurement. In the example illustrated in FIG. 5, the fluctuation reduction time period is 12 milliseconds.

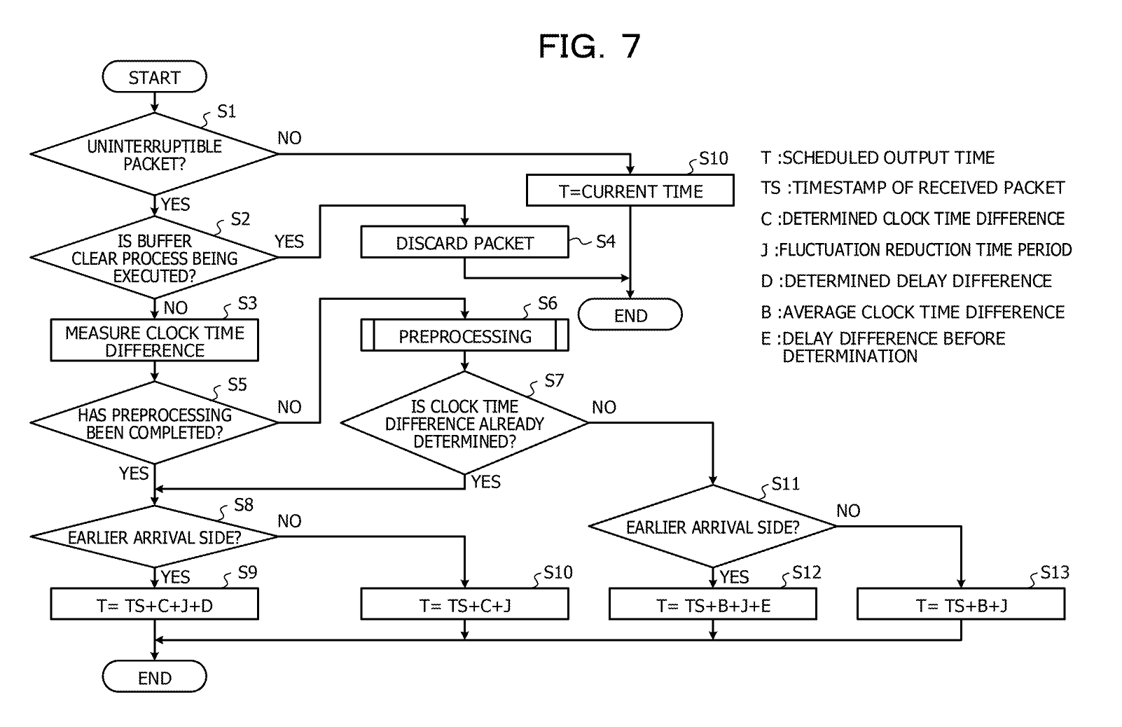

FIG. 7 is a flowchart illustrating an example of a phase control process. A process of this flowchart is executed by the phase controller 34 when the packet receiver 30 receives a packet. The process of this flowchart is executed for each of the sides A and B.

In S1, the phase controller 34 determines whether or not a received packet is an uninterruptible packet based on an uninterruptible flag added to a header of the received packet. If the received packet is the uninterruptible packet, the phase controller 34 determines whether or not a buffer clear process is being executed in S2. The buffer clear process is executed upon the detection of a failure and initializes the buffer memories of the packet buffer sections 33A and 33B.

If the buffer clear process is not being executed, the phase controller 34 measures a clock time difference in S3. The clock time difference is obtained by calculating the difference between a timestamp added to the received packet and an RTC value of the clock 39, as described above. If the buffer clear process is being executed, the phase controller 34 discards the received packet in S4.

In S5, the phase controller 34 determines whether or not preprocessing for the phase control has been completed. If the preprocessing has been completed, the process of the phase controller 34 proceeds to S8. On the other hand, if the preprocessing has not been completed, the phase controller 34 executes the preprocessing in S6. The preprocessing is described later. When the preprocessing is terminated, the phase controller 34 determines whether or not a clock time difference is already determined in S7. If the clock time difference is already determined, the process of the phase controller 34 proceeds to S8. This example assumes that the clock time difference is determined when the fluctuation reduction time period elapses after the start of the phase control process. On the other hand, if the clock time difference has yet to be determined, the process of the phase controller 34 proceeds to S11.

In S8 to S10, the phase controller 34 calculates scheduled output time of the received packet. Specifically, in S8, the phase controller 34 determines whether the received packet is a packet of the earlier arrival side or a packet of the later arrival side. If the received packet is the packet of the earlier arrival side, the scheduled output time is calculated by adding the determined clock time difference, the fluctuation reduction time period, and a determined delay difference to the timestamp of the received packet in S9. If the received packet is the packet of the later arrival side, the scheduled output time is calculated by adding the determined clock time difference and the fluctuation reduction time period to the timestamp of the received packet in S10. The determined clock time difference and the determined delay difference are calculated by the preprocessing of S6.

In S11 to S13, the phase controller 34 calculates the scheduled output time of the received packet. However, if S11 to S13 are executed, the determined clock time difference and the determined delay difference have yet to be obtained. Thus, if the received packet is the packet of the earlier arrival side, the scheduled output time is calculated by adding an average clock time difference, the fluctuation reduction time period, and a delay difference before determination to the timestamp of the received packet in S12. If the received packet is the packet of the later arrival side, the scheduled output time is calculated by adding the average clock time difference and the fluctuation reduction time period to the timestamp of the received packet in S13.

In this manner, the phase controller 34 calculates scheduled output time of each uninterruptible packet for each of the sides A and B. In this case, since a delay difference between the sides A and B is compensated, scheduled output time, calculated for the side A, of a packet having a certain sequence number added thereto is the same as scheduled output time, calculated for the side B, of a packet having the same certain sequence number added thereto. If the received packet is not the uninterruptible packet (No in S1), the phase controller 34 determines the scheduled output time of the received packet in S14. In this case, the current time is set as the scheduled output time.

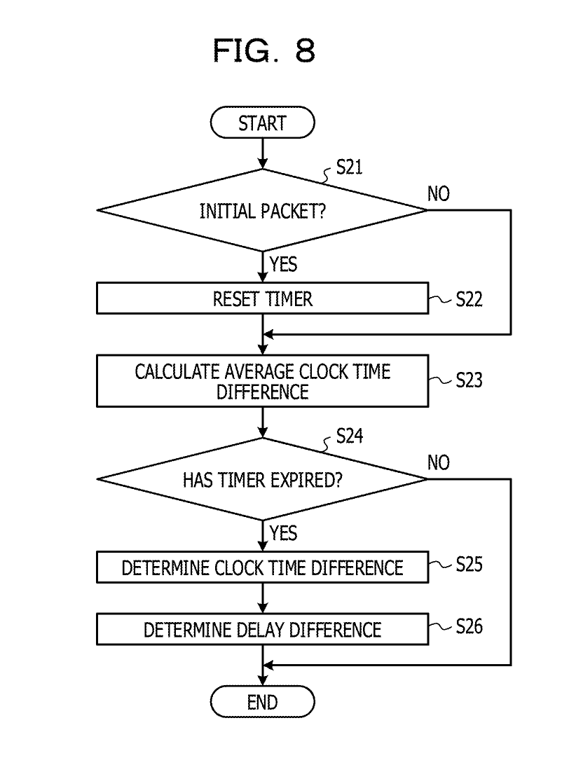

FIG. 8 is a flowchart illustrating an example of the preprocessing for the phase control. A process of this flowchart corresponds to S6 illustrated in FIG. 7.

In S21, the phase controller 34 determines whether or not the received packet is an initial packet after the start of the phase control. If the received packet is the initial packet, the phase controller 34 resets a timer for counting the fluctuation reduction time period in S22.

In S23, the phase controller 34 calculates the average clock time difference. Specifically, the average of differences between timestamps of received packets and RTC values within the packet receiver 30 is calculated. Then, in S24, the phase controller 34 determines whether or not the timer has expired. If the timer has expired, the phase controller 34 executes processes of S25 and S26. On the other hand, if the timer has not expired, the preprocessing is terminated.

In S25, the phase controller 34 determines the clock time difference between the packet transmitter 20 and the packet receiver 30. Specifically, the phase controller 34 acquires, as the determined clock time difference, the average clock time difference when the timer expires. Specifically, the average clock time difference when the fluctuation reduction time period elapses is stored as the determined clock time difference. The phase controller 34 determines a clock time difference for each of the sides A and B.

In S26, the phase controller 34 determines the delay difference between the side A and the side B. The determined delay difference indicates the difference between the determined clock time difference calculated for the side A and the determined clock time difference calculated for the side B.

In this manner, in the preprocessing for the phase control, determined clock time differences calculated for the sides, and a determined delay difference indicating the difference between the determined clock time difference calculated for the side A and the determined clock time difference calculated for the side B are obtained. Then, the determined clock time differences and the determined delay difference are used to determine scheduled output time of each of uninterruptible packets, as described above.

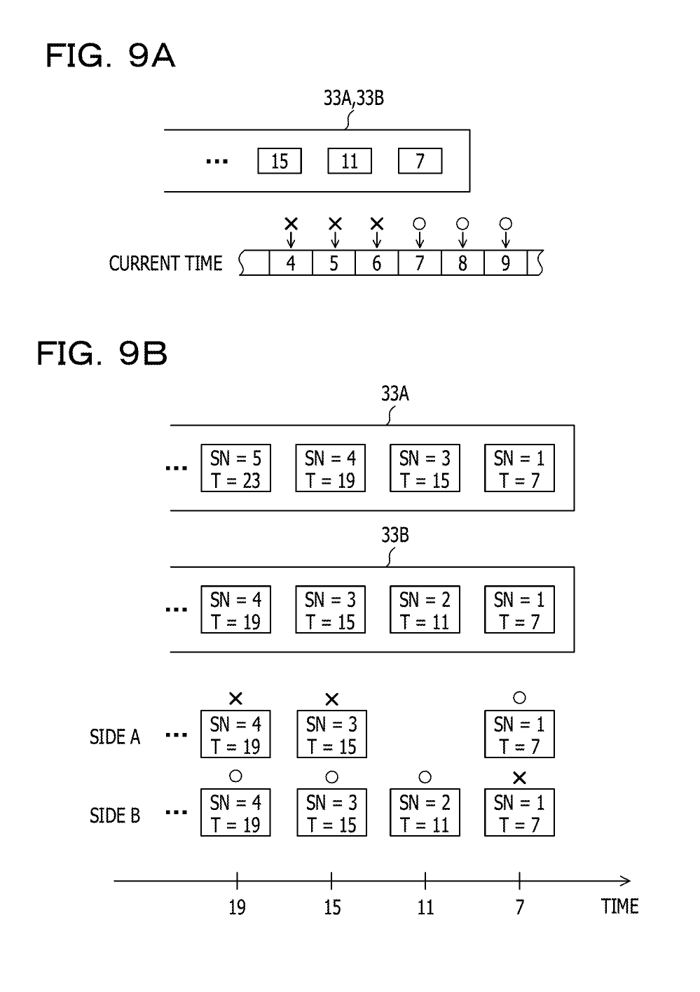

FIGS. 9A and 9B illustrate examples of an operation of the DEQ determiner 36. The DEQ determiner 36 executes dequeue determination on packets stored in the packet buffer section 33A and 33B. The dequeue determination is executed to determine whether or not the reading of the packets stored in the packet buffer sections is permitted. In this case, the DEQ determiner 36 compares the current time with scheduled output time of packets stored in tops of the packet buffer sections. When the current time reaches the scheduled output time, the DEQ determiner 36 gives a reading permission signal to the packet buffer sections.

In the example illustrated in FIG. 9A, the scheduled output time of the packets stored in the tops of the packet buffer sections (33A and 33B) is “7”. In this case, when the current time reaches “7”, the reading of the packets is permitted and the DEQ determiner 36 outputs the reading permission signal. When the reading permission signal is given to the packet buffer sections, the packets stored in the tops are read. Then, the packets read from the packet buffer sections are transmitted to the packet output section 37.

The DEQ determiner 36 executes the dequeue determination on the side A and the side B. In addition, the DEQ determiner 36 determines a selected side and an unselected side in the dequeue determination. In this case, the DEQ determiner 36 determines the selected side and the unselected side so that sequence numbers of packets read from the packet buffer sections are continuous. In the case where sequence numbers are continuous in each of the packet buffer sections, the selected side and the unselected side are determined so that the same side is continuously selected.

In the example illustrated in FIG. 9B, packets 1 are read from the sides A and B at time 7. In FIG. 9B, a packet i indicates a packet having a sequence number i added thereto. This example assumes that the side A is selected at time 7.

It is assumed that a packet 2 arrives at the packet receiver 30 via only the route B. Thus, the packet 2 is stored in only the packet buffer section 33B. Scheduled output time of the packet 2 is “11”. In this case, the packet 2 is read from only the side B at time 11, and the side B is selected.

Packets 3 arrive at the packet receiver 30 via the routes A and B and are stored in the packet buffer sections 33A and 33B. In addition, scheduled output time of the packets 3 is “15”. In this case, the packets 3 are read from the sides A and B at time 15. Since the side B is selected for the packet 2, the side B is selected for the packets 3.

The DEQ determiner 36 notifies the packet output section 37 of information indicating a selected side for each packet. Then, the packet output section 37 outputs a packet of the selected side and discards a packet of the unselected side.

In this manner, the packet receiver 30 selects either a packet received from the route A or a packet received from the route B and outputs the selected packet. In this case, the phase controller 34 controls output time of each of packets so that intervals at which the packets are output from the packet receiver 30 are equal to intervals at which the packets have been input to the transmitting node. Thus, highly reliable real-time communication (for example, streaming distribution or the like) is achieved.

<Failure Monitoring>

The packet transmitting apparatuses 1 monitor the state of the network to inhibit an abnormal packet from being transferred to a client. In this example, the packet receiver 30 of each packet transmitting apparatus 1 executes the following monitoring. An abnormal packet is discarded by the packet receiver 30.

(1) Delay Difference Abnormality

If the difference (or measured delay difference) between a clock time difference measured for the side A and a clock time difference measured for the side B is larger than a predetermined threshold, the packet receiver 30 determines that a delay difference abnormality has occurred. Specifically, if the difference between a transmission delay in the route A and a transmission delay in the route B is larger than the threshold, the delay difference abnormality is detected. As the threshold, the maximum delay difference defined for the network in advance is used, for example. The maximum delay difference is specified in accordance with a communication standard. Alternatively, the maximum delay difference may be specified by a network administrator or a user.

The measured delay difference is calculated according to the following equation in this example. The clock time difference measured for the side A indicates the difference between an RTC value of the clock 39 and a timestamp of a packet received via the route A. The clock time difference measured for the side B indicates the difference between an RTC value of the clock 39 and a timestamp of a packet received via the route B. The measured delay difference=the clock time difference measured for the side A−the clock time difference measured for the side B. In this case, if the measured delay difference is a positive value, the side A is determined as the later arrival side and the side B is determined as the earlier arrival side. On the other hand, if the measured delay difference is a negative value, the side A is determined as the earlier arrival side and the side B is determined as the later arrival side. If the measured delay difference is larger than the maximum delay difference, the packet receiver 30 determines that a failure has occurred in the route of the later arrival side, and the packet receiver 30 discards a received packet of the later arrival side. Thus, a packet that has arrived at the packet transmitting apparatus 1 via a route in which a transmission delay is significantly large is not transferred to a client. Whether or not the delay difference abnormality has occurred is monitored by the phase controller 34.

(2) Retention Time Period Overflow

If a time period (hereinafter referred to as retention time period) during which a received packet is stored in a packet buffer section is longer than a predetermined maximum retention time period, the packet receiver 30 determines that retention time period overflow has occurred. A retention time period of a received packet corresponds to a time period from the current time to scheduled output time of the packet. Thus, if scheduled output time of a received packet is after the current time, and the difference between the scheduled output time and the current time is longer than the maximum retention time period, the retention time period overflow is detected. It is preferable that the maximum retention time period be larger than the sum of the fluctuation reduction time period and the maximum delay time.

If the retention time period overflow is detected, the packet receiver 30 discards the received packet. Thus, a packet with abnormal latency is not transferred to a client. Whether or not the retention time period overflow has occurred is monitored by the phase controller 34.

(3) Retention Time Period Underflow

If the scheduled output time of the received packet is before the current time, it is estimated that the packet has already been transferred to a client. Thus, if the scheduled output time of the received packet is before the current time, the packet receiver 30 determines that retention time period underflow has occurred.

If the retention time period underflow is detected, the packet receiver 30 discards the received packet. Thus, the same packets are inhibited from being transferred to a client in a duplicated manner. Whether or not the retention time period underflow has occurred is monitored by the phase controller 34.

(4) Output Interruption

In a network in which packets are output at fixed time intervals, the packet receiver 30 may monitor whether or not output interruption has occurred. For example, if a certain packet is output at certain time and the next packet is not output after predetermined time elapses after the certain time, the packet receiver 30 determines that the output interruption has occurred.

In an intermittent communication network (for example, Ethernet), packets are transmitted at arbitrary time. In this case, a dummy packet is inserted in the packet transmitter 20 so that packets are transmitted at fixed time intervals. For example, if monitoring time intervals at which whether or not the output interruption has occurred is monitored are 3 milliseconds, dummy packets are inserted in the packet transmitter 20 so that packets are transmitted at time intervals of 1 milliseconds. It is preferable that the monitoring time intervals at which whether or not the output interruption has occurred is monitored be shorter than the fluctuation reduction time period. In addition, the packet receiver 30 discards dummy packets to inhibit the dummy packets from being transferred to a client.

(5) Packet Buffer Emptiness

If packets (including a dummy packet) are transmitted at fixed time intervals, the packet buffer sections 33A and 33B of the packet receiver 30 do not become empty. Thus, if the packet buffer sections 33A and 33B become empty, the packet receiver 30 determines that packet buffer emptiness has occurred. The packet buffer sections 33A and 33B include counters indicating queue lengths of the packet buffer sections. The counters are incremented when a packet is written to the packet buffer sections. The counters are decremented when a packet is read from the packet buffers. When either or both of values of the counters becomes or become 0, the packet buffer emptiness is detected.

In this manner, the packet receiver 30 monitors whether or not a failure has occurred in the network. If failures of the sides A and B are detected, either or both of a change from one of the routes to the other route and the replacement of a relay device is or are conducted. Thus, a transmission delay between the transmitting node and the receiving node after the restoration of the network is likely to be different from a transmission delay between the transmitting node and the receiving node before the restoration of the network. Thus, if the failures of the sides A and B are detected, the packet receiver 30 calculates clock time differences and a delay difference again. In the following description, a process of recalculating clock time differences and a delay difference due to the occurrence of a failure is referred to as “failure restoration process”.

The failure restoration process is executed when the delay difference abnormality, the retention time period overflow, the retention time period underflow, or the packet buffer emptiness is detected for the side A and when the delay difference abnormality, the retention time period overflow, the retention time period underflow, or the packet buffer emptiness is detected for the side B. In addition, the failure restoration process is executed when the output interruption is detected.

In the failure restoration process, the packet receiver 30 clears the packet buffer sections 33A and 33B and recalculates the clock time differences and the delay difference. As a result, a state in which the uninterruptible switching is able to be executed is restored. The packet receiver 30 discards a packet received during the execution of the failure restoration process. Thus, when the failure restoration process is executed, communication between clients is temporarily stopped.

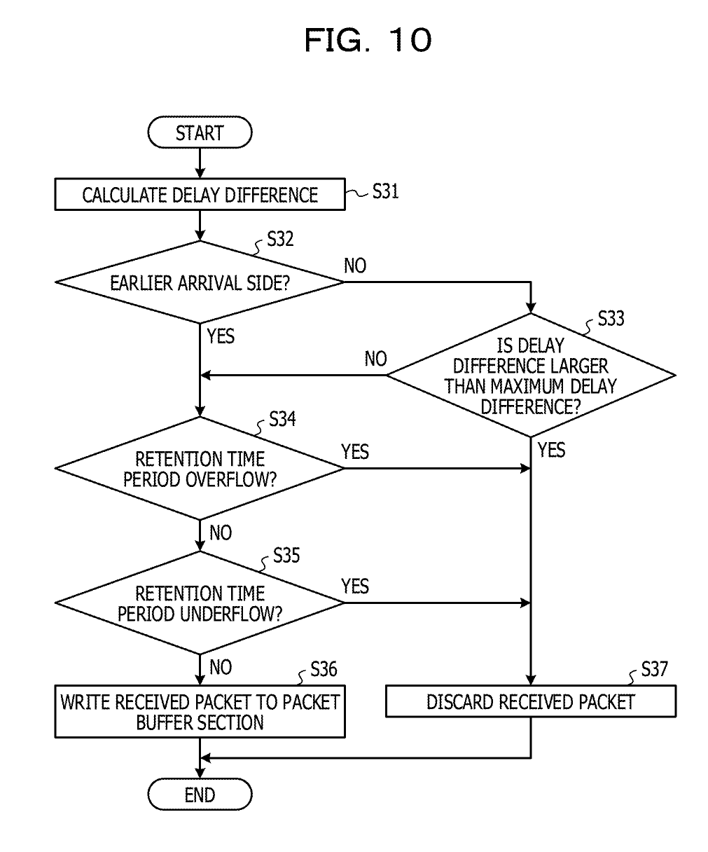

FIG. 10 is a flowchart illustrating an example of failure monitoring. This process is executed when scheduled output time of a received packet is calculated by the phase controller 34.

In S31, the phase controller 34 calculates a delay difference between the side A and the side B. This delay difference is obtained by subtracting a clock time difference measured for the side B from a clock time difference measured for the side A. The clock time difference measured for the side A indicates the difference between the time when a packet is received via the route A and a timestamp added to the packet. Similarly, the clock time difference measured for the side B indicates the difference between the time when a packet is received via the route B and a timestamp added to the packet.

In S32, the phase controller 34 determines whether or not a received packet is a packet of the earlier arrival side. Whether or not the received packet is the packet of the earlier arrival side is indicated by the sign of the delay difference obtained in S31.

If the received packet is not the packet of the earlier arrival side, the phase controller 34 determines whether or not the absolute value of the delay difference obtained in S31 is larger than the maximum delay difference in S33. If the absolute value of the delay difference obtained in S31 is larger than the maximum delay difference, the phase controller 34 determines that the delay difference abnormality has occurred. Specifically, a failure of a route via which the received packet has been transmitted is detected.

In S34, the phase controller 34 monitors whether or not the retention time period overflow has occurred. If scheduled output time of the received packet is after the current time, and the difference between the scheduled output time and the current time is larger than the maximum retention time period, the retention time period overflow is detected.

In S35, the phase controller 34 monitors whether or not the retention time period underflow has occurred. If the scheduled output time of the received packet is before the current time, the retention time period underflow is detected.

If the delay difference abnormality, the retention time period overflow, and the retention time period underflow are not detected, the packet receiver 30 writes the received packet to a packet buffer section in S36. On the other hand, if the delay difference abnormality, the retention time period overflow, or the retention time period underflow is detected, the packet receiver 30 discards the received packet in S37.

In the example illustrated in FIG. 10, whether or not the delay difference abnormality, the retention time period overflow, and the retention time period underflow have occurred is monitored, but the embodiment is not limited to this configuration. Specifically, the packet receiver 30 may monitor whether or not one or more of the delay difference abnormality, the retention time period overflow, the retention time period underflow, the output interruption, and the packet buffer emptiness have occurred.

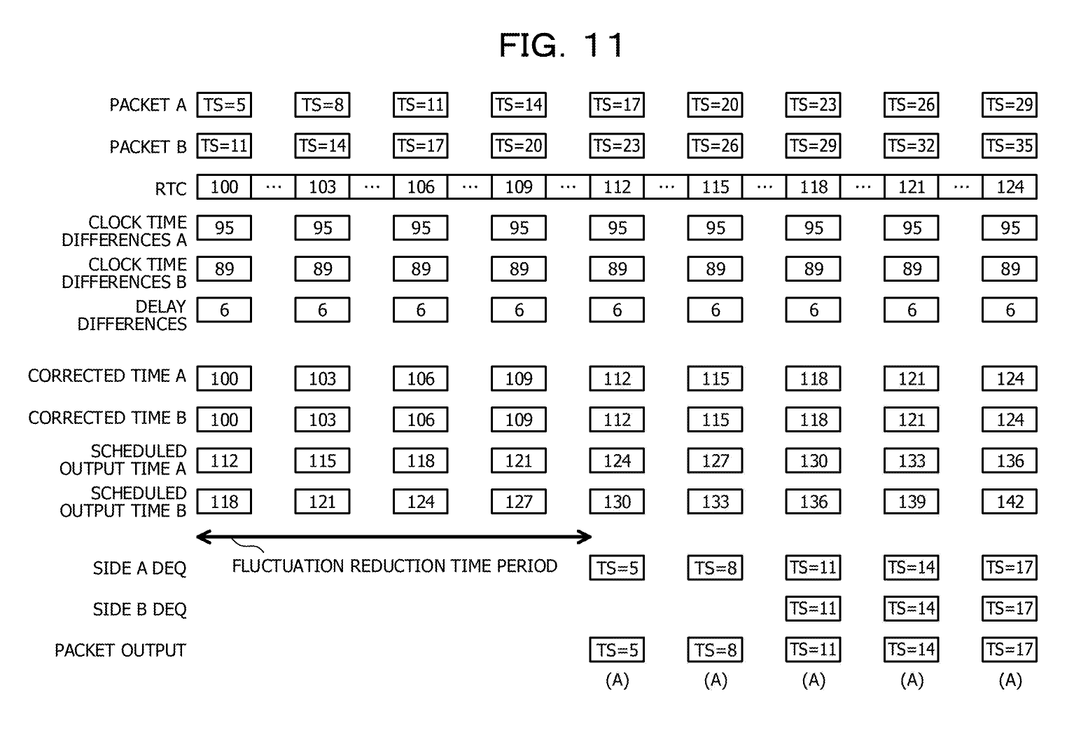

FIGS. 11 to 13 illustrate examples of the phase control and the failure monitoring. Packets A indicate packets that have arrived at the receiving node via the route A. Packets B indicate packets that have arrived at the receiving node via the route B. RTC indicates RTC values of the clock 39 included in the packet receiver 30. Specifically, RTC indicates the current time indicated in the packet receiver 30. Clock time differences A indicate differences between the RTC values and timestamps of the packets A and correspond to transmission delays in the route A. Clock time differences B indicate differences between the RTC values and timestamps of the packets B and correspond to transmission delays in the route B. Delay differences indicate differences between the clock time differences A and the clock time differences B. In this example, the delay differences are obtained by subtracting the clock time differences B from the clock time differences A.

Corrected time A is obtained by adding the clock time differences A to the timestamps of the packets A. However, after the fluctuation reduction time period elapses, corrected time A is obtained by adding a determined clock time difference A to timestamps of packets A. The determined clock time difference A indicates an average of clock time differences A when the fluctuation reduction time period elapses. Corrected time B is obtained by adding the clock time differences B to the timestamps of the packets B. However, after the fluctuation reduction time period elapses, corrected time B is obtained by adding a determined clock time difference B to timestamps of packets B. The determined clock time difference B indicates an average of clock time differences B when the fluctuation reduction time period elapses.

Scheduled output time A indicates scheduled output time of the packets A and is obtained by adding the fluctuation reduction time period to the corrected time A. Scheduled output time B indicates scheduled output time of the packets B and is obtained by adding the fluctuation reduction time period to the corrected time B. For the earlier arrival side, scheduled output time is obtained by adding the fluctuation reduction time period and a determined delay difference to corrected time. In this example, in the case packets A and B are transmitted from the transmitting node at the same time, the packet B arrives at the packet receiver 30 earlier than the packet A. Thus, the scheduled output time B is obtained by adding the fluctuation reduction time period and the determined delay difference to the corrected time B. The determined delay difference indicates the difference between the average of clock time differences A and the average of clock time differences B when the fluctuation reduction time period elapses.

Side A DEQ indicates packets read from the packet buffer section 33A. Side B DEQ indicates packets read from the packet buffer section 33B. Packet output indicates packets output from the packet receiver 30. An expression “(A)” added to the packets output from the packet receiver 30 indicates a selected side. In the example illustrated in FIG. 11, packets A read from the packet buffer section 33A are selected and output from the packet receiver 30.

In addition, the following parameters are set. The parameters are the fluctuation reduction time period of 12 (milliseconds), the maximum delay difference of 36 (milliseconds), and the maximum retention time period of 60 (milliseconds).

The transmitting node outputs the same packets via the routes A and B at the same time. The packets have a timestamp added thereto. Specifically, the same timestamp is added to two packets to be transmitted from the transmitting node at the same time.

In the following description, time indicated by an RTC value is merely referred to as “time” in some cases. In this case, for example, time corresponding to RTC=100 is expressed as “time 100”. In addition, a packet having a timestamp indicating a value x is referred to as “packet x” in some cases. For example, A packet having a timestamp TS=5 added thereto is referred to as “packet 5” in some cases. In addition, a “clock time difference” may be a measured clock time difference, an average clock time difference, or a determined clock time difference.

Packets transmitted by the transmitting node arrive at the packet receiver 30. For example, at time 100, the packet receiver 30 receives a packet 5 via the route A and receives a packet 11 via the route B. At time 103, the packet receiver 30 receives a packet 8 via the route A and receives a packet 14 via the route B. At time 106, the packet receiver 30 receives the packet 11 via the route A and receives a packet 17 via the route B.

In the case where the packet 11 is transmitted via the route A, the packet 11 arrives at the packet receiver 30 at time 106. In the case where the packet 11 is transmitted via the route B, the packet 11 arrives at the packet receiver 30 at time 100. In other words, the transmission delay in the route B is shorter than the transmission delay in the route A.

The phase controller 34 measures a clock time difference for each of the sides. For example, “95 (=100−5)” is calculated as a clock time difference A for the packet 5 received via the route A at time 100, and “89 (=100−11)” is calculated as a clock time difference B for the packet 11 received via the route B at time 100.

The phase controller 34 measures the delay difference between the side A and the side B based on the clock time differences measured for the sides. For example, “6 (=95−89)” is calculated as the delay difference for time 100. Since the delay difference is a positive value, it is determined that the side B is the earlier arrival side.

The phase controller 34 calculates the corrected time for the sides. The corrected time is calculated by adding the clock time differences to the timestamps added to the received packets, as described above. Thus, for example, “100 (5+95)” is calculated as corrected time A for time 100, and “100 (=11+89)” is calculated as corrected time B for time 100.

The phase controller 34 calculates scheduled output time of the output packets. For the earlier arrival side, scheduled output time is calculated by adding the fluctuation reduction time period and the delay difference to corrected time. For the later arrival side, scheduled output time is calculated by adding the fluctuation reduction time period to corrected time. For example, “112 (=100+12)” is calculated as scheduled output time A of the packet 5 received via the route A at time 100. In addition, “118 (=100+12+6)” is calculated as scheduled output time of the packet 11 received via the route B at time 100. In this example, the fluctuation reduction time period is “12”.

Every time a packet arrives at the packet receiver 30, the phase controller 34 calculates scheduled output time of the packet. In addition, a packet A that has arrived at the packet receiver 30 via the route A is stored in the packet buffer section 33A, and a packet B that has arrived at the packet receiver 30 via the route B is stored in the packet buffer section 33B.

When the fluctuation reduction time period elapses after the start of the phase control, the phase controller 34 determines the clock time difference A, the clock time difference B, and the delay difference. In this example, the determined clock time difference A, the determined clock time difference B, and the determined delay difference are “95”, “89”, and “6 (the side B or earlier arrival side)”, respectively.

The DEQ determiner 36 generates a DEQ instruction by comparing scheduled output time of a packet and the current time (or RTC value). For example, the scheduled output time A of the packet 5 that has arrived at the packet receiver 30 via the route A at time 100 is “112”. Thus, at time 112, the DEQ determiner 36 gives a DEQ instruction to read the packet 5 to the packet buffer section 33A. Then, the packet buffer section 33A reads the packet 5, and the packet output section 37 outputs the packet 5.

The scheduled output time A of the packet 11 that has arrived at the packet receiver 30 via the route A at time 106 is “118”. In addition, the scheduled output time B of the packet 11 that has arrived at the packet receiver 30 via the route B at time 100 is also “118”. In this case, at time 118, the DEQ determiner 36 gives a DEQ instruction to read the packet 11 to the packet buffer section 33A and gives a DEQ instruction to read the packet 11 to the packet buffer section 33B. Then, the packet buffer sections 33A and 33B read the packets 11, respectively. This example assumes that the side A is selected. Then, the packet output section 37 outputs the packet 11 read from the packet buffer section 33A.

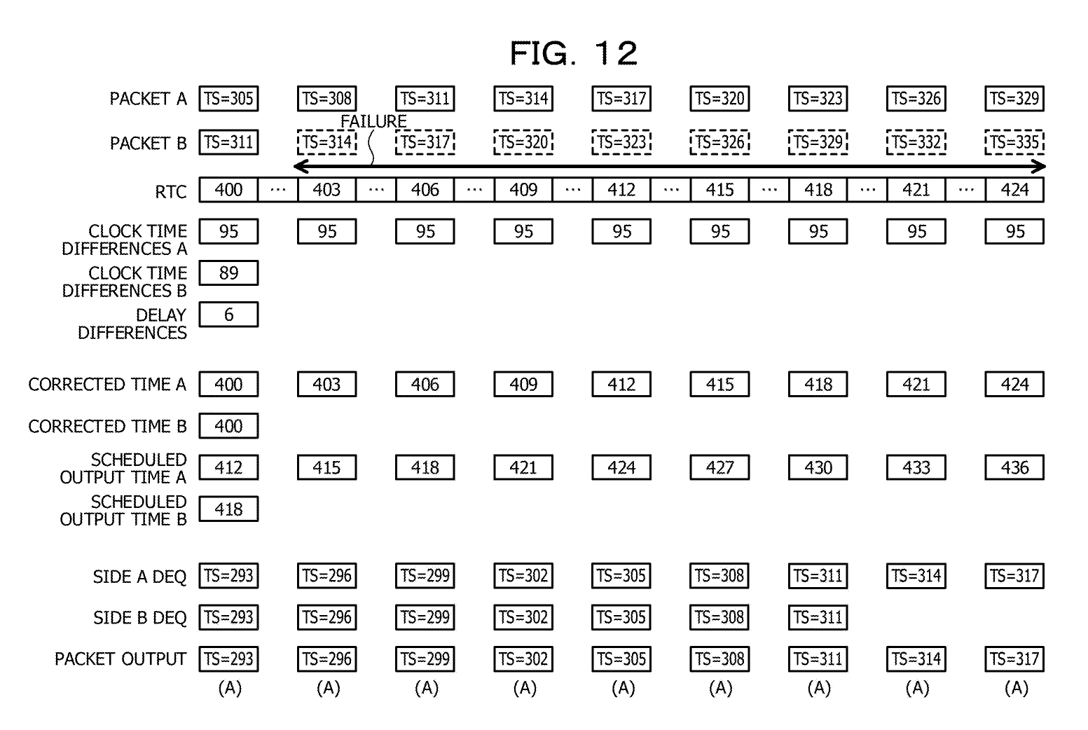

After that, as illustrated in FIG. 12, a failure occurs in the route B, and packets (packets 314, 317, 320, . . . ) after the packet 311 arrive at the packet receiver 30 via only the route A. In this case, the packet receiver 30 transfers the packets received via the route A to a client.

It is assumed that the packets (for example, packets 314, 317, 320, and 323) after the packet 311 in the route B are held by a relay node on the route B. It is assumed that when the route B is restored, the relay node transmits the held packets toward a destination node. In this case, these packets arrive at the packet receiver 30 after being significantly delayed. In the following description, these packets are referred to as “delayed packets” in some cases.

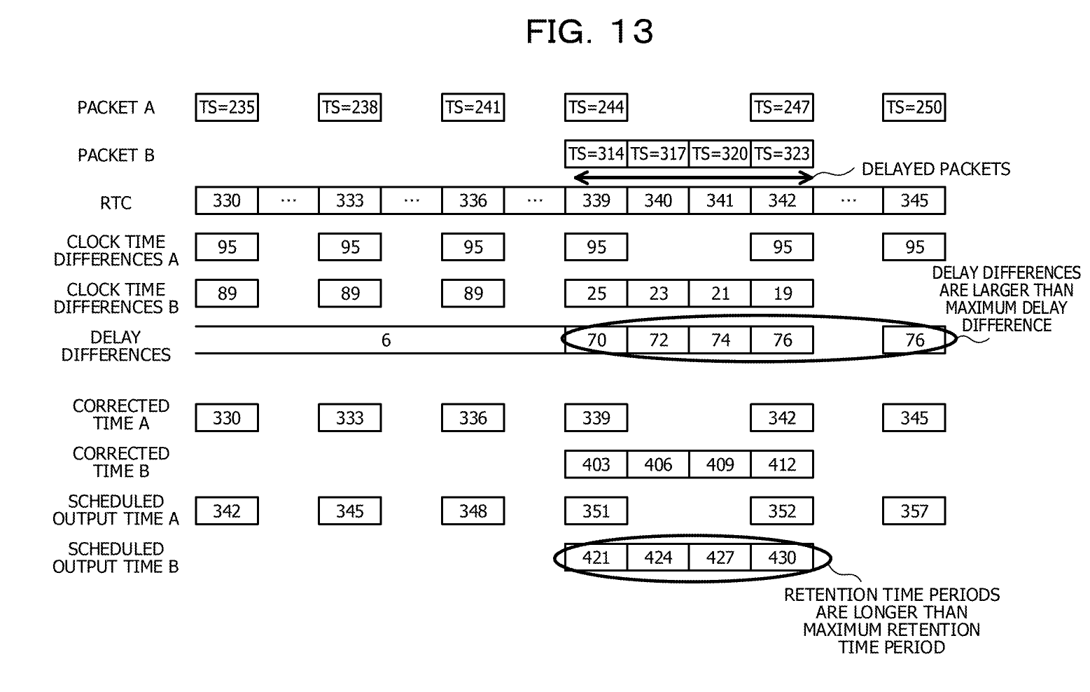

The delayed packet 314 is transmitted via the route B and arrives at the packet receiver 30 at time 339, as illustrated in FIG. 13. A packet 244 transmitted via the route A arrives at the packet receiver 30 at time 339. Thus, the phase controller 34 uses timestamps of these packets to calculate clock time differences, a delay difference, and scheduled output time.

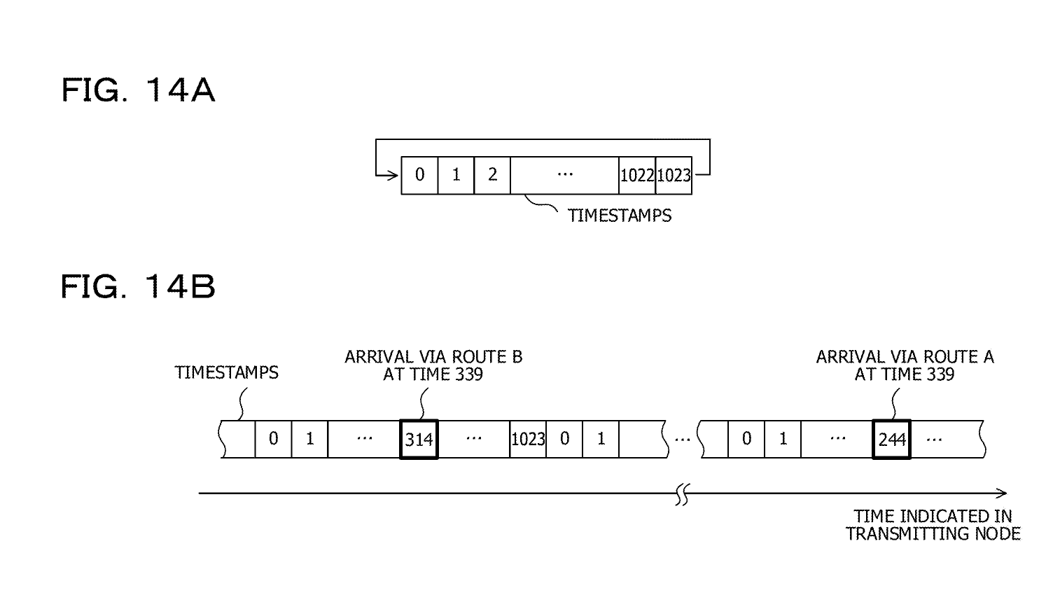

Timestamps added to packets in the transmitting node are indicated by a cyclic counter of a predetermined bit length in this example. For example, if the bit length of the cyclic counter is 10 bits, the timestamps are indicated using “0” to “1023”, as illustrated in FIG. 14A. Thus, if a transmission delay is long, it may not be possible to determine which one of packets arrives earlier or later than the other packet based on timestamps.

For time 339, the phase controller 34 calculates the clock time differences A and B, the delay difference, the corrected time A and B, and the scheduled output time A and B. It is assumed that the clock time difference (or determined clock time difference A) determined for the side A is “95” and that the clock time difference (or determined clock time difference B) determined for the side B is “89”. In this case, the determined delay difference calculated from the determined clock time difference A and the determined clock time difference B is “6”. In FIG. 11, the determined clock time differences and the determined delay difference are identified upon the elapse of the fluctuation reduction time period and recorded in a register. The results of the calculation for time 339 are as follows. The measured clock time difference A=RTC−TS=339−244=95; the measured clock time difference B=RTC−TS=339−314=25; the measured delay difference=the measured clock time difference A−the measured clock time difference B=95−25=+70; the corrected time A=TS+the determined clock time difference A=244+95=339; the corrected time B=TS+the determined clock time difference B=314+89=403; the scheduled output time A=the corrected time A+the fluctuation reduction time period=339+12=351; and the scheduled output time B=the corrected time B+the fluctuation reduction time period+the determined delay difference=403+12+6=421.

Subsequently, the phase controller 34 of the packet receiver 30 executes the failure monitoring using the aforementioned calculation results. For example, whether or not the delay difference abnormality has occurred is monitored by comparing the measured delay difference with the maximum delay difference. In this example, the maximum delay difference is 36. Specifically, the measured delay difference calculated for time 339 exceeds the maximum delay difference. In this case, the phase controller 34 determines that a failure has occurred in a route via which a packet of the later arrival side has been transmitted, and the phase controller 34 discards the packet of the later arrival side. In this case, since the delay difference is a positive value, the side A is determined as the later arrival side. Thus, the phase controller 34 discards the packet 244 received via the route A. Similarly, packets 247, 250, and the like received via the route A are discarded due to the delay difference abnormality.

Whether or not the retention time period overflow has occurred is monitored by comparing a retention time period of a received packet with the maximum retention time period. The retention time period of the received packet is indicated by the difference between scheduled output time of the received packet and the current time (RTC value in this case). In this example, the difference between scheduled output time of the packet 314 of the side B and the RTC value is 70, and the maximum retention time period is 60. The retention time period of the packet 314 received via the route B is longer than the maximum retention time period. Thus, the phase controller 34 determines that a failure has occurred in the route B, and the phase controller 34 discards the packet 314 received via the route B. Similarly, the packets 317, 320, 323, and the like received via the route B are discarded due to the retention time period overflow.

In this manner, in the example illustrated in FIGS. 12 and 13, packets of the sides A and B are discarded due to the failure of the route B. In this case, the packet receiver 30 discards packets stored in the packet buffer sections 33A and 33B and recalculates clock time differences and a delay difference (failure restoration process). As a result, communication is temporarily stopped. It is, however, not preferable that the communication be stopped due to a failure of only one of the routes.

This problem is caused by the fact that the bit length of the cyclic counter that generates timestamps is finite. For example, the time when the packet 314 that arrives from the route B at time 339 is generated is before the time when the packet 244 that arrives from the route A at time 339 is generated, as illustrated in FIG. 14B. However, when the delay difference between the route A and the route B is calculated based on the values of the timestamps, it is determined that the packet 244 has been generated before the generation of the packet 314. As a result, in the cases illustrated in FIGS. 12 and 13, the delay difference abnormality is detected for the packet 244 transmitted via the route A.

This problem may be solved by, for example, making sufficiently long the bit length of the cyclic counter that generates timestamps. However, if bit lengths of timestamps are long, a hardware circuit that processes packets is large in size. It is, therefore, not preferable that the bit length of the cyclic counter be long.

### Embodiment

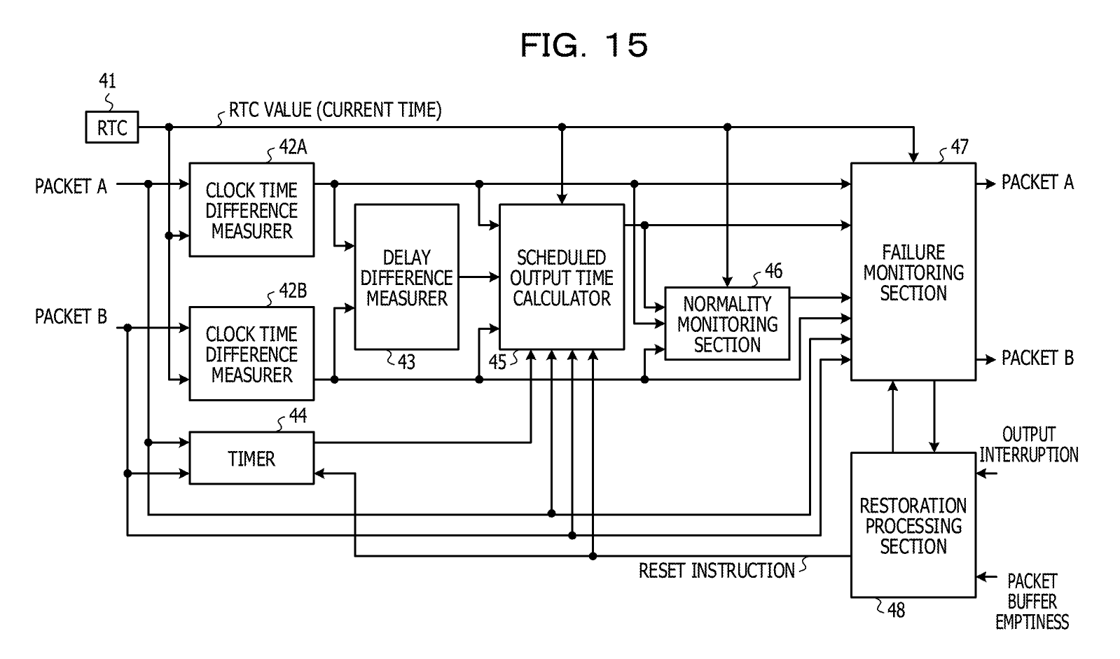

FIG. 15 illustrates an example of the phase controller included in each of the packet transmitting apparatuses according to the embodiment. As illustrated in FIG. 3, the phase controller 34 is included in the packet receiver 30.

The phase controller 34 includes an RTC generator 41, clock time difference measurers 42A and 42B, a delay difference measurer 43, a fluctuation reduction time period measurement timer 44, a scheduled output time calculator 45, a normality monitoring section 46, a failure monitoring section 47, and a restoration processing section 48. The phase controller 34, however, may include another element not illustrated in FIG. 15. In addition, the RTC generator 41 may be installed outside the phase controller 34. Packet control information (including a flow number, an uninterruptible flag, a sequence number, and a timestamp) of each received packet is given to the phase controller 34.

The RTC generator 41 includes the cyclic counter indicating a value to be counted up based on a predetermined standard frequency and outputs the counted value. The standard frequency of the RTC generator 41 is the same as a standard frequency of the clock used to generate timestamps in the transmitting node.

The clock time difference measurer 42A measures, from a timestamp added to a packet (hereinafter referred to as packet A) received via the route A and an RTC value generated by the RTC generator 41, a clock time difference (hereinafter referred to as clock time difference A) between the transmitting node and the packet receiver 30 upon the reception of the packet A via the route A. In addition, the clock time difference measurer 42B measures, from a timestamp added to a packet (hereinafter referred to as packet B) received via the route B and an RTC value, a clock time difference (hereinafter referred to as clock time difference B) between the transmitting node and the packet receiver 30 upon the reception of the packet B via the route B. Furthermore, the clock time difference measurer 42A calculates an average value of clock time differences A and the clock difference measurer 42B calculates an average value of clock time differences B.

The delay difference measurer 43 identifies the delay difference based on the clock time difference A and the clock time difference B. This delay difference indicates the difference between a transmission delay in the route A and a transmission delay in the route B. In addition, the delay difference is calculated by subtracting the clock time difference B from the clock time difference A, for example.

The fluctuation reduction time period measurement timer 44 is activated when an initial packet of a target flow to be subjected to the phase control arrives at the packet receiver 30. Then, when the fluctuation reduction time period determined in advance elapses, the fluctuation reduction time period measurement timer 44 outputs a timer expiration signal.

Upon receiving the timer expiration signal from the fluctuation reduction time period measurement timer 44, the scheduled output time calculator 45 determines the clock time differences and the delay difference. Then, the scheduled output time calculator 45 uses timestamps of received packets and the determined clock time differences to calculate scheduled output time of the received packets. In this case, the difference between the transmission delay in the route A and the transmission delay in the route B is compensated using the determined delay difference.

The normality monitoring section 46 monitors the normality of the routes. In this example, the normality monitoring section 46 uses the measured clock time differences and the scheduled output time to determine whether or not the routes are normal. Then, the normality monitoring section 46 notifies the results of monitoring the routes to the failure monitoring section 47. For example, if a route to be monitored is normal, the normality monitoring section 46 outputs a normality confirmation signal.

The failure monitoring section 47 monitors whether or not the aforementioned delay difference abnormality, the retention time period overflow, and the retention time period underflow have occurred. However, upon receiving a normality confirmation signal from the normality monitoring section 46, the failure monitoring section 47 does not execute the failure monitoring. For example, upon receiving a normality confirmation signal for the route A, the failure monitoring section 47 does not execute the failure monitoring on the route A (or the side A) and executes the failure monitoring on only the route B (or the side B).

If failures of the sides A and B are detected or if the output interruption is detected by the packet output section 37, the restoration processing section 48 executes the failure restoration process. In the failure restoration process, the packet buffer sections 33A and 33B are cleared. Then, when the packet buffer sections 33A and 33B are completely cleared, the restoration processing section 48 transmits a reset instruction to the fluctuation reduction time period measurement timer 44 and the scheduled output time calculator 45. The fluctuation reduction time period measurement timer 44 is reset by the reset instruction and starts counting the fluctuation reduction time period again. In addition, upon receiving the reset instruction, the scheduled output time calculator 45 recalculates the determined clock time differences and the determined delay difference.

In the phase controller 34 having the aforementioned configuration, the normality monitoring section 46 monitors the following normality.

(1) Normality of Clock Time Differences

If a clock time difference (hereinafter referred to as measured clock time difference) measured for a received packet is in a predetermined range, the normality monitoring section 46 determines that a route via which the packet has been transmitted is normal. Lower and upper limits of the predetermined range are, for example, “a determined time clock difference−the fluctuation reduction time period” and “the determined time clock difference+the fluctuation reduction time period”. In this case, the determined clock time difference corresponds to an average value of measured clock time differences. The fluctuation reduction time period corresponds to the maximum fluctuation time period in which the maximum fluctuation may occur in the network. The fluctuation time period is caused by a variation in time periods during which the relay devices on the routes process packets. The maximum value of the variation in the time periods during which the relay devices on the routes process the packets is determined in accordance with the communication standard or the like in advance. For example, if five relay devices are installed on a route, and the maximum value of a variation in a time period during which each of the relay devices processes a packet is 1 millisecond, the maximum fluctuation time period of the route is 5 milliseconds.

Each of the measured clock time differences corresponds to the difference between a timestamp added to a packet in the transmitting node and an RTC value of the RTC generator 41 upon the arrival of the packet at the packet receiver 30. Specifically, the measured clock time difference indicates a measured value of a transmission delay in a route between the transmitting node and the packet receiver 30. In this case, if the measured value of the transmission delay in the route between the transmitting node and the packet receiver 30 is close to an estimated transmission delay (standard value of the transmission delay), the route is considered to be normal. Thus, if the measured clock time difference is close to the standard value of the transmission delay, the route between the transmitting node and the packet receiver 30 is considered to be normal.

Thus, standard values of the transmission delays are determined. The transmission delays, however, may vary for each packet. Thus, the standard values of the transmission delays are obtained by measuring the transmission delays multiple times and calculating averages of the measured transmission delays. In the phase controller 34, the determined clock time differences obtained by averaging the measured clock time differences are used as the standard values of the transmission delays. A time period for the averaging corresponds to the fluctuation reduction time period (or the maximum fluctuation time period).

Variations in the transmission delays measured for packets are caused by fluctuations within the relay devices included in the nodes on the routes, as described above. The fluctuations may not be caused by an abnormal operation and may occur in a normal operation. Thus, if a fluctuation in a transmission delay in a route via which a packet has been transmitted is in a range estimated in advance, the route is considered to be normal. Specifically, if a measured value (or measured clock time difference) of a transmission delay is larger than “a determined clock time difference−the fluctuation reduction time period” and smaller than “the determined clock time difference+the fluctuation reduction time period”, it is determined that the route is normal.

(2) Normality of Scheduled Output Time

If the difference between scheduled output time determined for a received packet and the current time is smaller than predetermined time, the normality monitoring section 46 determines that a route via which the packet has been transmitted is normal. Specifically, if the scheduled output time of the received packet is after the current time and before predetermined threshold time, it is determined that the route via which the packet has been transmitted is normal. The scheduled output time is as follows. Scheduled output time calculated for the earlier arrival side=a timestamp of a received packet+a determined clock time difference+the fluctuation reduction time period+a determined delay difference. Scheduled output time calculated for the later arrival side=a timestamp of a received packet+a determined clock time difference+the fluctuation reduction time period.

The determined delay difference corresponds to the difference between the transmission delays in the two routes. A determined clock time difference indicates the average of measured clock time differences. A measured clock time difference is obtained by subtracting a timestamp of a received packet from an RTC value (or the current time) of the packet receiver 30. In this case, if variations in the transmission delays in the routes are ignored, the current time indicated by the clock of the packet receiver 30 is obtained by adding the determined clock time difference to the timestamp of the received packet. Thus, if the variations in the transmission delays in the routes are ignored, the scheduled output time is expressed by the following equation. The scheduled output time calculated for the earlier arrival side=the current time+the fluctuation reduction time period+the determined delay difference. The scheduled output time calculated for the later arrival side=the current time+the fluctuation reduction time period.

In fact, the transmission delays, however, may vary for each packet. Thus, if fluctuations in transmission delays in the routes are considered, a range of scheduled output time that is considered to be normal for the earlier arrival side is as follows. The scheduled output time that is considered to be normal for the earlier arrival side is after “the current time+the fluctuation reduction time period+the determined delay difference−the maximum fluctuation time period” and before “the current time+the fluctuation reduction time period+the determined delay difference+the maximum fluctuation time period”.

In this example, the maximum fluctuation time period is used as the fluctuation reduction time period. Thus, a range of scheduled output time that is considered to be normal for the earlier arrival side is as follows. The scheduled output time that is considered to be normal for the earlier arrival side is after “the current time+the determined delay difference” and before “the current time+2×the fluctuation reduction time period+the determined delay difference”.

In addition, there is not a problem if the scheduled output time is after the current time. Thus, if the scheduled output time satisfies the following requirement, it may be determined that the route of the earlier arrival side is normal. The requirement is that the scheduled output time is after “the current time” and before “the current time+2×the fluctuation reduction time period+the determined delay difference”.

Alternatively, if the maximum fluctuation time period is used for expression, instead of the fluctuation reduction time period, and the scheduled output time satisfies the following requirement, it may be determined that the route of the earlier arrival side is normal. The requirement is that the scheduled output is after “the current time” and before “the current time+2×the maximum fluctuation time period+the determined delay difference”.

In addition, a range of scheduled output time that is considered to be normal for the later arrival side is as follows. The scheduled output time that is considered to be normal for the later arrival side is after “the current time +the fluctuation reduction time period−the maximum fluctuation time period” and before “the current time+the fluctuation reduction time period+the maximum fluctuation time period”.

In this example, the maximum fluctuation time period is used as the fluctuation reduction time period. Thus, a range of scheduled output time that is considered to be normal for the later arrival side is as follows. The scheduled output time that is considered to be normal for the later arrival side is after “the current time” and before “the current time+2×the fluctuation reduction time period”.

Alternatively, if the maximum fluctuation time period is used for expression, instead of the fluctuation reduction time period, and the scheduled output time satisfies the following requirement, it may be determined that the route of the later arrival side is normal. The requirement is that the scheduled output is after “the current time” and before “the current time+2×the maximum fluctuation time period”.

The normality monitoring section 46 monitors, for each of the routes, either or both of the normality of clock time differences and the normality of scheduled output time. The failure monitoring section 47 does not monitor a route determined to be normal by the normality monitoring section 46.

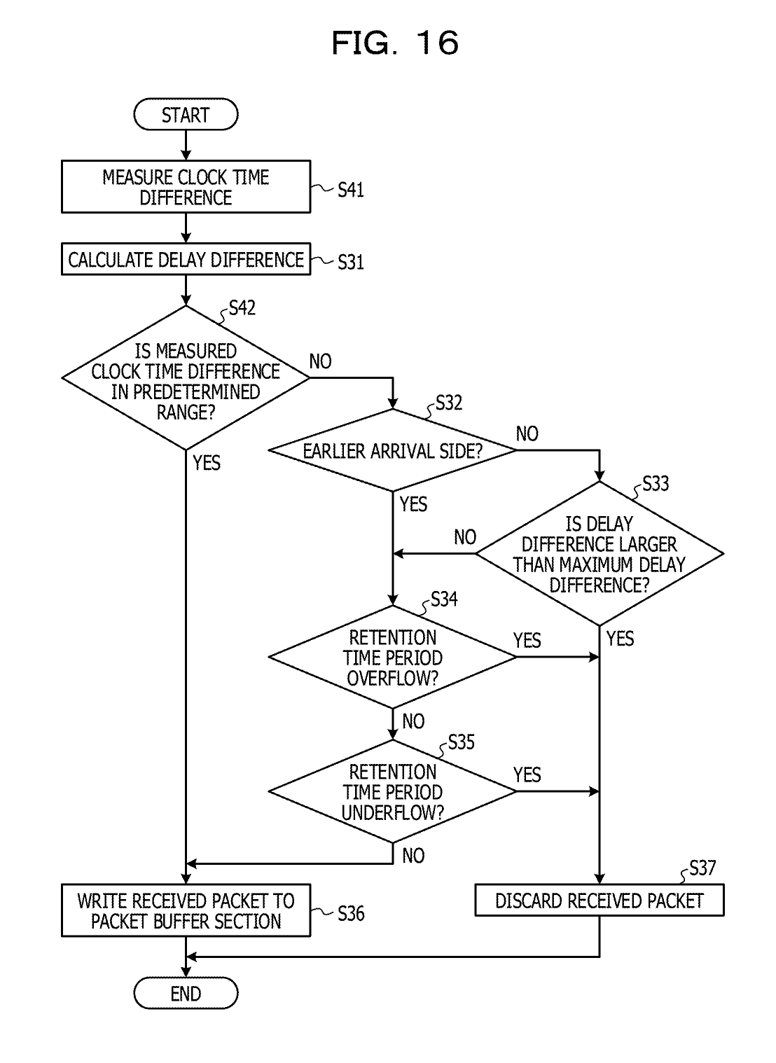

FIG. 16 is a flowchart illustrating an example of a process to be executed by the phase controller 34. In the flowchart illustrated in FIG. 16, the normality of clock time differences is monitored. A process of the flowchart illustrated in FIG. 16 is executed for each of the routes.

In S41, the clock time difference measurer (42A or 42B) uses a timestamp of a received packet to measure a clock time difference between the transmitting node and the packet receiver 30. A measured clock time difference calculated for the side A indicates the difference between an RTC value generated by the RTC generator 41 upon the arrival of a packet via the route A and a timestamp added to the packet. A measured clock time difference calculated for the side B indicates the difference between an RTC value generated by the RTC generator 41 upon the arrival of a packet via the route B and a timestamp added to the packet.

In S31, the delay difference measurer 43 calculates a delay difference between the side A and the side B. The delay difference is obtained by subtracting the measured clock time difference calculated for the side B from the measured clock time difference calculated for the side A.

In S42, the normality monitoring section 46 determines whether or not the clock time difference measured in S41 is in a predetermined range. In this case, the measured clock time difference indicates a transmission delay between the transmitting node and the packet receiver 30. Thus, the normality monitoring section 46 determines whether or not the transmission delay is in the predetermined range. Lower and upper limits of the predetermined range are “a determined clock time difference−the fluctuation reduction time period” and “the determined clock time period+the fluctuation reduction time period”.

If the measured clock time difference (or the transmission delay) is in the predetermined range, the normality monitoring section 46 determines that a route via which the received packet has been transmitted is normal. In this case, the failure monitoring section 47 does not execute S32 to S35 included in the failure monitoring. Then, the phase controller 34 causes the received packet to be stored in a packet buffer section (33A or 33B) in S36.

If the measured clock time difference (or the transmission delay) is out of the predetermined range, the failure monitoring section 47 executes S32 to S35 included in the failure monitoring. Processes of S32 to S35 illustrated in FIG. 16 are substantially the same as the processes of S32 to S35 illustrated in FIG. 10, and a description thereof is omitted. If a failure is not detected as a result of the failure monitoring, the phase controller 34 causes the received packet to be stored in the packet buffer section (33A or 33B) in S36. On the other hand, if the failure is detected, the phase controller 34 discards the received packet in S37.

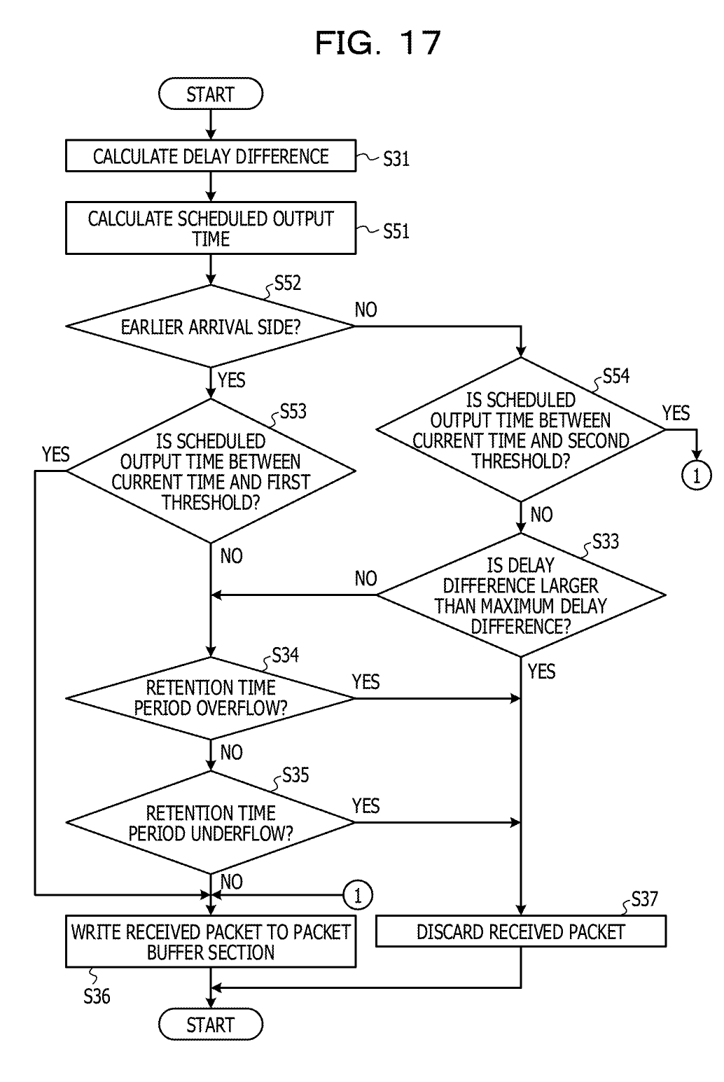

FIG. 17 is a flowchart illustrating another example of the process to be executed by the phase controller 34. In the flowchart illustrated in FIG. 17, the normality of scheduled output time is monitored. A process of the flowchart illustrated in FIG. 17 is executed for each of the routes.

In S51, the scheduled output time calculator 45 calculates scheduled output time of a received packet. The scheduled output time of the received packet is calculated based on a timestamp added to the packet, a determined clock time difference, and the fluctuation reduction time period. Regarding the earlier arrival side, however, scheduled output time of a received packet is calculated based on a timestamp added to the packet, a determined clock time difference, the fluctuation reduction time period, and a determined delay difference.

In S52, the phase controller 34 determines whether or not the received packet is a packet of the earlier arrival side. Whether or not the received packet is the packet of the earlier arrival side is determined based on the sign of the delay difference obtained in S31.

If the received packet is the packet of the earlier arrival side, the normality monitoring section 46 determines whether or not the scheduled output time of the received packet is between the current time and first threshold time in S53. The first threshold time is “the current time+2×the fluctuation reduction time period+the determined delay difference”. If the scheduled output time is between the current time and the first threshold time, the normality monitoring section 46 determines that the route via which the received packet has been transmitted is normal. In this case, the failure monitoring section 47 does not execute S33 to S35 included in the failure monitoring. Then, the phase controller 34 causes the received packet to be stored in a packet buffer section (33A or 33B) in S36.

On the other hand, if the received packet is a packet of the later arrival side, the normality monitoring section 46 determines whether or not the scheduled output time of the received packet is between the current time and second threshold time in S54. The second threshold time is “the current time+2×the fluctuation reduction time period”. If the scheduled output time is between the current time and the second threshold time, the normality monitoring section 46 determines that the route via which the received packet has been transmitted is normal. In this case, the failure monitoring section 47 does not execute S33 to S35 included in the failure monitoring. Then, the phase controller 34 causes the received packet to be stored in a packet buffer section (33A or 33B) in S36.

If the received packet is the packet of the earlier arrival side, and the scheduled output time of the received packet is not between the current time and the first threshold time, the failure monitoring section 47 executes S34 and S35 included in the failure monitoring. If the received packet is the packet of the later arrival side, and the scheduled output time of the received packet is not between the current time and the second threshold time, the failure monitoring section 47 executes S33 to S35 included in the failure monitoring. Processes of S33 to S35 illustrated in FIG. 17 are substantially the same as the processes of S33 to S35 illustrated in FIG. 10, and a description thereof is omitted.

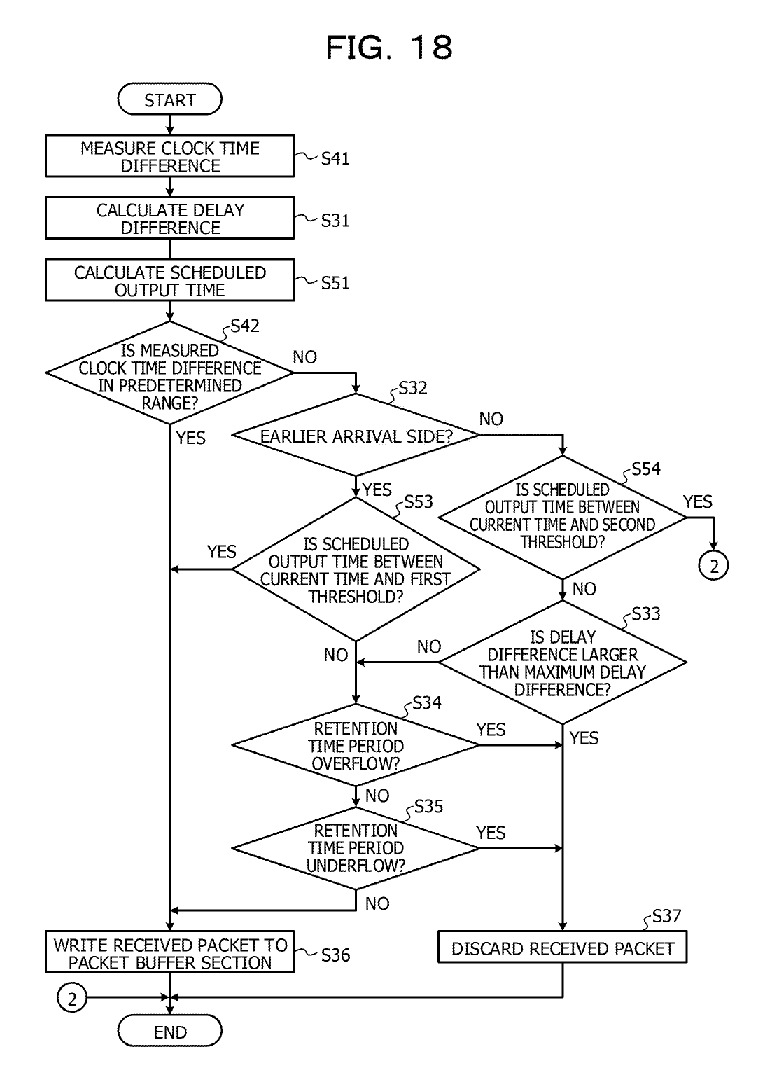

FIG. 18 is a flowchart illustrating still another example of the process to be executed by the phase controller 34. In the flowchart illustrated in FIG. 18, the normality of clock time differences and the normality of scheduled output time are monitored. A process of the flowchart illustrated in FIG. 18 is executed for each of the routes.

In the example illustrated in FIG. 18, if it is determined that a target route is normal based on either or both of a clock time difference and scheduled output time, the failure monitoring section 47 does not execute the failure monitoring on the target route. In the example illustrated in FIG. 18, the normality of the scheduled output time is checked after the monitoring of the normality of the clock time difference but may be checked before the monitoring of the normality of the clock time difference.

As described above, each of the packet transmitting apparatuses 1 according to the embodiment includes the normality monitoring section 46. The normality monitoring section 46 monitors the normality of the routes A and B. The failure monitoring section 47 monitors whether or not a failure has occurred in a route determined not to be normal by the normality monitoring section 46. Thus, erroneous detection, in which it is determined that a failure has occurred in both of the routes regardless of the fact that one of the routes is normal, is suppressed and stable uninterruptible communication is achieved.

For example, in the example illustrated in FIG. 12, the failure occurs in only the route B. In other words, the route A is normal. However, if the failure monitoring is executed without the execution of the normality monitoring, failures of the sides A and B may be detected, as illustrated in FIG. 13. In this case, the failure restoration process is executed and communication is temporarily stopped.

On the other hand, according to the failure detection method according to the embodiment, the normality monitoring section 46 monitors the normality of the routes. For example, in the case where the normality of clock time differences is monitored in the normality monitoring, whether or not measured clock time differences are in the predetermined range is determined. In the examples illustrated in FIGS. 11 to 13, the determined clock time difference (or average of measured clock time differences calculated for the side A) calculated for the side A is “95”. The fluctuation reduction time period (or the maximum fluctuation time period) is “12”. Thus, a range to be used to determine the normality of the clock time difference calculated for the side A is “95±12”. As illustrated in FIG. 13, for the time (RTC=339) when the delayed packet arrives via the route B, a measured delay difference for the side B is “95 (=339−244)”. Thus, it is determined that the side A is normal and the failure monitoring is not executed on the side A. As a result, erroneous failure detection is not executed on the side A.

In addition, in the case where scheduled output time is monitored in the normality monitoring, whether or not the scheduled output time of a received packet is in a predetermined range is determined. In the example illustrated in FIG. 13, since the measured delay difference is the positive value for the time (RTC=339) when the delayed packet arrives via the route B, it is determined that the side A is the later arrival side. In this case, a range to be used to determine the normality of the scheduled output time of the received packet that has arrived on the side A at time 339 is a range of “339 (=the current time)” to “363 (=339+2×12)”. The scheduled output time of the received packet is “351 (=339+12)”. In this case, it is determined that the side A is normal and the failure monitoring is not executed on the side A. As a result, erroneous failure detection is not executed on the side A.

In the case where a failure has occurred in only the route B, if it is determined that the route A is normal, the packet receiver 30 does not execute the failure monitoring on the route A. Thus, erroneous failure detection is not executed on the side A and the packet receiver 30 does not execute the failure restoration process. Thus, the stop of communication due to a failure that has occurred in only one of the routes is avoided.

The phase controller 34 included in each of the packet transmitting apparatuses 1 is achieved by a hardware circuit, for example. In this case, each of the clock time difference measurers 42A and 42B includes a circuit that calculates the difference between a timestamp added to a received packet and an RTC value generated by the RTC generator 41 to obtain a measured clock time difference, and a circuit that averages the measured clock time difference. The delay difference measurer 43 includes a circuit that calculates the difference between measured clock time differences calculated by the clock time difference measurers 42A and 42B to obtain a measured delay difference. The scheduled output time calculator 45 includes a circuit that determines a clock time difference, a circuit that determines a delay difference, and a circuit that calculates scheduled output time. The circuit that calculates scheduled output time includes a circuit that adds the maximum fluctuation time period to an RTC value, and a circuit that adds the maximum fluctuation time period and a determined delay difference to an RTC value. In the case where the normality monitoring section 46 monitors the normality of a clock time difference, the normality monitoring section 46 includes a circuit that compares a measured clock time difference with thresholds (lower threshold and upper threshold). In the case where the normality monitoring section 46 monitors the normality of scheduled output time, the normality monitoring section 46 includes a circuit that compares scheduled output time with the threshold time. The failure monitoring section 47 includes a circuit that compares a measured delay difference with the maximum delay difference, a circuit that compares scheduled output time with the current time, and a circuit that compares the difference between scheduled output time and the current time with a threshold.

A portion or all of the functions of the phase controller 34 may be achieved by software. In this case, the phase controller 34 includes a processor system. The processor system includes a memory and a processor element that executes a program in which a portion or all of the functions of the phase controller 34 is or are described.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A transmitting apparatus comprising:
a memory; and
a processor coupled to the memory and configured to:
receive a first packet including first data transmitted from a transmitting node via a first route, and receive a second packet including the first data transmitted from the transmitting node via a second route different from the first route;
identify, based on first time information regarding the first packet, a first state of the first route, and identify, based on second time information regarding the second packet, a second state of the second route, respectively; and
when the first state is not in a first state range, execute a first failure monitoring process on the first route, and when the second state is not in a second state range, execute a second failure monitoring process on the second route, respectively.

2. The transmitting apparatus according to claim 2, wherein
the processor is configured to:
identify the first state of the first route based on at least one of a first time length and a first difference, the first time length indicating a time length for transmission of the first packet from the transmitting node to the transmitting apparatus, and the first difference indicating a time difference between first scheduled output time of the first packet to be output from the transmitting apparatus to another node and first reception time when the first packet is received by the transmitting apparatus; and
identify the second state of the second route based on at least one of a second time length and a second time difference, the second time length indicating a time length for the transmission of the second packet from the transmitting node to the transmitting apparatus, and the second difference indicating a time difference between second scheduled output time of the second packet to be output from the transmitting apparatus to another node and second reception time when the second packet is received by the transmitting apparatus;

3. The transmitting apparatus according to claim 2, wherein
the processor is configured to:
even when a difference between the first time length and the second time length is greater than a threshold value, not execute the first failure monitoring process when the first state is in the first state range, and not execute the second failure monitoring process when the second state is in the second range.

4. The transmitting apparatus according to claim 3, wherein
the processor is configured to:
execute the first failure monitoring process when the first time period is not in a first time range; and
execute the second failure monitoring process when the second time period is not in a second time range.

5. The transmitting apparatus according to claim 3, wherein
the processor is configured to:
execute the first failure monitoring process when the first difference is not in a first difference range; and
execute the second failure monitoring process when the second difference is not in a second difference range.

6. The transmitting apparatus according to claim 3, wherein
the processor is configured to:
not execute the first failure monitoring process when a first transmission delay in the first route is greater than a second transmission delay in the second route, and the first scheduled output time is after the first reception time and before threshold time obtained by adding twice the maximum value of a fluctuation in the first transmission delay to current time.

7. The transmitting apparatus according to claim 3, wherein
the processor is configured to:
not execute the first failure monitoring process when a first transmission delay in the first route is less than a second transmission delay in the second route, and the first scheduled output time is after the first reception time and before threshold time obtained by adding twice the maximum value of a fluctuation in the first transmission delay and a difference between the first transmission delay and the second transmission delay to the first reception time.

8. The transmitting apparatus according to claim 3, wherein
the processor is configured to:
execute the first failure monitoring process when the first state is not in the first state range, a first transmission delay in the first route is greater than a second transmission delay in the second route, and a difference between the first transmission delay and the second transmission delay is larger than a threshold.

9. A method executed by a transmitting apparatus, the method comprising:
receiving a first packet including first data transmitted from a transmitting node via a first route;
receiving a second packet including the first data transmitted from the transmitting node via a second route different from the first route;
identifying, based on first time information regarding the first packet, a first state of the first route, and identifying, based on second time information regarding the second packet, a second state of the second route, respectively; and
when the first state is not in a first state range, executing a first failure monitoring process on the first route, and when the second state is not in a second state range, executing a second failure monitoring process on the second route, respectively.

10. The method according to claim 9, wherein
in identifying the first state, the first state is identified based on at least one of a first time length and a first difference, the first time length indicates a time length for transmission of the first packet from the transmitting node to the transmitting apparatus, and the first difference indicates a time difference between first scheduled output time of the first packet to be output from the transmitting apparatus to another node and first reception time when the first packet is received by the transmitting apparatus, and
in identifying the second state, the second state is identified based on at least one of a second time length and a second time difference, the second time length indicates a time length for the transmission of the second packet from the transmitting node to the transmitting apparatus, and the second difference indicates a time difference between second scheduled output time of the second packet to be output from the transmitting apparatus to another node and second reception time when the second packet is received by the transmitting apparatus.

11. The method according to claim 10, wherein
even when a difference between the first time length and the second time length is greater than a threshold value, the first failure monitoring process is not executed when the first state is in the first state range, and the second failure monitoring process is not executed when the second state is in the second range.

12. The method according to claim 11, wherein
the first failure monitoring process is executed when the first time period is not in a first time range, and
the second failure monitoring process is executed when the second time period is not in a second time range.

13. The method according to claim 11, wherein
the first failure monitoring process is executed when the first difference is not in a first difference range, and
the second failure monitoring process is executed when the second difference is not in a second difference range.

14. The method according to claim 11, wherein
the first failure monitoring process is not executed when a first transmission delay in the first route is greater than a second transmission delay in the second route, and the first scheduled output time is after the first reception time and before threshold time obtained by adding twice the maximum value of a fluctuation in the first transmission delay to current time.

15. A non-transitory computer-readable storage medium storing a program that causes an information processing apparatus to execute a process, the process comprising:
receiving a first packet including first data transmitted from a transmitting node via a first route;
receiving a second packet including the first data transmitted from the transmitting node via a second route different from the first route;
identifying, based on first time information regarding the first packet, a first state of the first route, and identifying, based on second time information regarding the second packet, a second state of the second route, respectively; and
when the first state is not in a first state range, executing a first failure monitoring process on the first route, and when the second state is not in a second state range, executing a second failure monitoring process on the second route, respectively.

16. The non-transitory computer-readable storage medium according to claim 15, wherein
in identifying the first state, the first state is identified based on at least one of a first time length and a first difference, the first time length indicates a time length for transmission of the first packet from the transmitting node to the transmitting apparatus, and the first difference indicates a time difference between first scheduled output time of the first packet to be output from the transmitting apparatus to another node and first reception time when the first packet is received by the transmitting apparatus, and
in identifying the second state, the second state is identified based on at least one of a second time length and a second time difference, the second time length indicates a time length for the transmission of the second packet from the transmitting node to the transmitting apparatus, and the second difference indicates a time difference between second scheduled output time of the second packet to be output from the transmitting apparatus to another node and second reception time when the second packet is received by the transmitting apparatus.

17. The non-transitory computer-readable storage medium according to claim 16, wherein
even when a difference between the first time length and the second time length is greater than a threshold value, the first failure monitoring process is not executed when the first state is in the first state range, and the second failure monitoring process is not executed when the second state is in the second range.

18. The non-transitory computer-readable storage medium according to claim 17, wherein
the first failure monitoring process is executed when the first time period is not in a first time range; and
the second failure monitoring process is executed when the second time period is not in a second time range.

19. The non-transitory computer-readable storage medium according to claim 17, wherein
the first failure monitoring process is executed when the first difference is not in a first difference range, and
the second failure monitoring process is executed when the second difference is not in a second difference range.

20. The non-transitory computer-readable storage medium according to claim 17, wherein
the first failure monitoring process is not executed when a first transmission delay in the first route is greater than a second transmission delay in the second route, and the first scheduled output time is after the first reception time and before threshold time obtained by adding twice the maximum value of a fluctuation in the first transmission delay to current time.
